(19) United States
(12) Patent Application Publication
(10) Pub. No.: US 2026/0208162 A1
(43) Pub. Date: Jul. 23, 2026

(54) Method and catalyst for producing ammonia

(71) Applicants: ROYAL MELBOURNE INSTITUTE OF TECHNOLOGY, Melbourne, Victoria (AU); Queensland University of Technology, Brisbane, Queensland (AU)

(72) Inventors: Torben Jost Daeneke, Melbourne, Victoria (AU); Ken Kin Kwong Chiang, Melbourne, Victoria (AU); Karma Zuraiqi, Melbourne (AU); Sarina Sarina, Brisbane, Queensland (AU); Yichao Jin, Brisbane, Queensland (AU)

(21) Appl. No.: 19/142,532

(22) PCT Filed: Dec. 20, 2023
(86) PCT No.: PCT/AU2023/051344

§ 371 Date: Jun. 23, 2025

(30) Foreign Application Priority Data
Dec. 23, 2022 (AU) 2022903994

(51) Int. Cl. B01J 23/08; B01J 10/00; B01J 23/62; B01J 23/66; B01J 23/825; B01J 35/27; B01J 37/00; B01J 37/04; B01J 37/08; B01J 37/34; B22F 9/06; C01C 1/04; C22C 28/00

(52) U.S. Cl. CPC B01J 23/08; B01J 10/005; B01J 23/62; B01J 23/66; B01J 23/825; B01J 35/27; B01J 37/0081; B01J 37/04; B01J 37/08; B01J 37/343; B22F 9/06; C01C 1/0411; C01C 1/0447; C22C 28/00; B22F 2009/065; B22F 2301/30; B22F 2304/10; B22F 2999/00

(57) ABSTRACT

The invention provides a method of producing ammonia, the method comprising: providing a catalyst comprising supported metallic microdroplets, the metallic microdroplets comprising (i) at least one low-melting metal element selected from gallium and indium, and (ii) at least one promotor metal element selected from the group 1-2 and 7-11 metals; and contacting the catalyst with gas comprising dinitrogen and dihydrogen, at a reaction temperature sufficiently high that the metallic microdroplets comprise a liquid metal alloy of the at least one low-melting metal element and the at least one promotor metal element, thereby reacting the dinitrogen and dihydrogen to form ammonia.

### PRIORITY CROSS-REFERENCE

The present application claims priority from Australian provisional patent application No. 2022903994 filed on 23 Dec. 2022, the contents of which should be considered to be incorporated into this specification by this reference.

### TECHNICAL FIELD

The invention relates to a method of producing ammonia, from dinitrogen and dihydrogen, using a catalyst comprising supported metallic microdroplets. At the ammonia synthesis reaction temperature, the metallic microdroplets comprise a liquid metal alloy of a low-melting metal element selected from gallium and indium and a promotor metal element selected from the group 1-2 and 7-11 metals. The invention further relates to a catalyst, to a method of producing a catalyst, and to a reaction system for ammonia synthesis.

### BACKGROUND OF INVENTION

Ammonia (NH₃) is currently produced at industrial scale primarily by the Haber-Bosch process. This process for producing NH₃ from dinitrogen (N₂) and dihydrogen (H₂) is extremely energy intensive due in part to the high reaction temperatures and pressures (e.g. 500° C. and 200 bar) required to achieve significant conversions, with typical energy consumption of over 30 GJ/tonne NH₃. The resulting carbon emissions of about 2.2 kg CO₂/kg NH₃ make the Haber-Bosch process one of the most carbon-intensive industrial processes, accounting for 1.6% of annual global CO₂ emissions. It would therefore be desirable to operate an ammonia synthesis process at milder process conditions. However, this is challenging due to the limited catalyst activities of the solid heterogeneous catalysts used in the Haber-Bosch process.

Furthermore, the solid catalysts used in the Haber-Bosch process are susceptible to deactivation over time, for example due to hydrogen embrittlement or poisoning by impurities in the feed. This is compounded by the high cost of state-of-the-art catalysts which include precious metals such as ruthenium.

Other proposed processes for ammonia synthesis involve a chemical looping approach where the nitrogen fixation and hydrogenation steps are separated, adding undesirable complexity to the process design and operation.

There is therefore an ongoing need for new methods of producing ammonia which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect the invention provides a method of producing ammonia, the method comprising: providing a catalyst comprising supported metallic microdroplets, the metallic microdroplets comprising (i) at least one low-melting metal element selected from gallium and indium, and (ii) at least one promotor metal element selected from the group 1-2 and 7-11 metals; and contacting the catalyst with gas comprising dinitrogen and dihydrogen, at a reaction temperature sufficiently high that the metallic microdroplets comprise a liquid metal alloy of the at least one low-melting metal element and the at least one promotor metal element, thereby reacting the dinitrogen and dihydrogen to form ammonia.

Different from conventional approaches to ammonia synthesis such as the Haber-Bosch process, the method of the present invention uses a catalyst phase which is present partly or entirely as a liquid metal alloy at the catalyst operating temperature. The catalyst is present in the form of supported metallic microdroplets, thus providing a large catalytic surface area to facilitate the ammonia synthesis reaction. The inventors have found that such catalysts can provide high and stable activities under ammonia synthesis conditions, even at low pressures. Without wishing to be limited by any theory, this is attributed to a synergistic cooperation between the low-melting metal element and the promotor metal element in the liquid metal alloy, to the inherent resistance of liquid metal compositions to catalyst degradation mechanisms such as hydrogen embrittlement and catalyst poisoning, and to the surprising stability of the finely divided microdroplet morphology under ammonia synthesis conditions.

The liquid metal alloy of the catalyst microdroplets under operating conditions typically includes enough of the promotor metal element to significantly increase the catalyst activity relative to comparably sized unpromoted liquid metal microdroplets containing only the low-melting metal element. However, producing supported metallic microdroplets containing catalytically significant quantities of the promotor metal element, preferably distributed in similar concentrations in most or all of the microdroplets, is a non-trivial undertaking. This is due to the low solubility of the promotor metal element in gallium- or indium-based liquid metal compositions at low (e.g. near-ambient) temperature conditions. The issue is not avoided merely by producing the alloy at high temperature, since the promotor metal element has been found to precipitate out, typically as an intermetallic compound, when the bulk metal alloy is cooled.

Preferred embodiments of the present invention have thus only been realised through the development of a new catalyst preparation method where the catalytic liquid metal alloy is dispersed by sonication at high temperatures-above the melting point of the alloy and any intermetallic compounds that can form therein-in a thermally stable liquid solvent. The resultant microdroplets therefore each contain a similar liquid metal alloy composition. Upon cooling, to allow microdroplet recovery from the solvent and supportation on a suitable solid support, the promotor metal element may still precipitate from the liquid metal alloy, for example as an intermetallic compound. However, this precipitation occurs within each microdroplet such that a substantial proportion of the microdroplets contain a “reservoir” of the precipitated promotor metal element, fully contained within the microdroplet, which melts back into the liquid metallic alloy when the catalyst is heated to the operating temperature for ammonia synthesis. As a result, the catalyst is highly active due to the microdroplet morphology and substantially homogeneous distribution of promotor metal.

In some embodiment of the first aspect, the at least one promotor metal element is fully dissolved in the liquid metal alloy at the reaction temperature.

In some embodiments, the reaction temperature is above 200° C., or above 250° C., or above 300° C., such as above 350° C., for example in the range of 350° C. to 500° C.

In some embodiments, at least a proportion of the metallic microdroplets comprise (i) a solid metal alloy or intermetallic compound enriched in the at least one promotor metal element and (ii) a second metallic phase enriched in the at least one low-melting metal element when the catalyst is at room temperature. At least 50% of the metallic microdroplets, such as at least 80% of the metallic microdroplets, may comprise the solid metal alloy or intermetallic compound and the second metallic phase.

In some embodiments, at least a proportion of the metallic microdroplets comprise (i) a solid metal alloy or intermetallic compound enriched in the at least one promotor metal element and (ii) a liquid metal phase enriched in the at least one low-melting metal element when the catalyst temperature is about 50° C. At least 50% of the metallic microdroplets, such as at least 80% of the metallic microdroplets, may comprise the solid metal alloy or intermetallic compound and the liquid metal phase.

In some embodiments, each metallic microdroplet has substantially the same metallic composition.

In some embodiments, the at least one low-melting metal element comprises gallium.

In some embodiments, the at least one promotor metal element is selected from the group consisting of copper, silver, gold, nickel, palladium, platinum, cobalt, iron, ruthenium and manganese.

In some embodiments, the at least one promotor metal element is selected from copper and magnesium. For example, the at least one promotor metal element may comprise copper.

In some embodiments, the metallic microdroplets comprise the at least one promotor metal element in an amount of between 0.1 and 20 wt. %, such as between 0.5 and 10 wt. %, for example between about 1 and 5 wt. %, based on the total weight of the metallic microdroplets.

In some embodiments, the metallic microdroplets are supported on a solid support, optionally selected from a carbon-based support, a metal support, a metal oxide support and a ceramic support.

In some embodiments, the metallic microdroplets are predominantly between 100 nm and 10 μm in size.

In some embodiments, the catalyst is contacted with the gas comprising dinitrogen and dihydrogen at a total pressure of between 1 and 100 bar, or between 1 and 50 bar, such as between 1 and 10 bar, for example between 2 and 6 bar.

In accordance with a second aspect the invention provides a catalyst comprising supported metallic microdroplets, the metallic microdroplets comprising (i) at least one low-melting metal element selected from gallium and indium, and (ii) at least one promotor metal element selected from the group 1-2 and 7-11 metals, wherein at least a proportion of the metallic microdroplets comprise (i) a solid metal alloy or intermetallic compound enriched in the at least one promotor metal element and (ii) a second metallic phase enriched in the at least one low-melting metal element. The catalyst may have this morphology when at room temperature.

In some embodiments of the second aspect, at least 50% of the metallic microdroplets, such as at least 80% of the metallic microdroplets, comprise the solid metal alloy or intermetallic compound and the second metallic phase.

In some embodiments, at least 50% of the metallic microdroplets, such as at least 80% of the metallic microdroplets comprise the solid metal alloy or intermetallic compound and a liquid metal phase enriched in the at least one low-melting metal element when the catalyst temperature is about 50° C.

In some embodiments, the metallic microdroplets comprise a liquid metal alloy of the at least one low-melting metal element and the at least one promotor metal element when the catalyst is heated to a temperature is about 400° C. or higher, for example when the catalyst temperature is about 350° C. or higher, wherein the at least one promotor metal element is fully dissolved in the liquid metal alloy.

In some embodiments, each metallic microdroplet has substantially the same metallic composition.

In some embodiments, the at least one low-melting metal element comprises gallium.

In some embodiments, the at least one promotor metal element is selected from the group consisting of copper, silver, gold, nickel, palladium, platinum, cobalt, iron, ruthenium and manganese.

In some embodiments, the at least one promotor metal element is selected from copper and magnesium. For example, the at least one promotor metal element may comprise copper.

In some embodiments, the metallic microdroplets comprise the at least one promotor metal element in an amount of between 0.1 and 20 wt. %, such as between 0.5 and 10 wt. %, for example between about 1 and 5 wt. %, based on the total weight of the metallic microdroplets.

In some embodiments, the metallic microdroplets are supported on a solid support, optionally selected from a carbon-based support, a metal support, a metal oxide support and a ceramic support.

In accordance with a third aspect the invention provides a method of producing a catalyst, the method comprising: contacting a metallic alloy with a high-temperature solvent, the metallic alloy comprising (i) at least one low-melting metal element selected from gallium and indium, and (ii) at least one promotor metal element selected from the group 1-2 and 7-11 metals; applying ultrasonic energy to the metallic alloy within the high-temperature solvent, the high-temperature solvent being at a droplet formation temperature that is above the melting point of the metallic alloy, and above the melting point of any intermetallic compound that can be formed therein, thereby separating the liquid metallic alloy into metallic microdroplets of the metallic alloy within the high-temperature solvent; separating the metallic microdroplets from the high-temperature solvent; and supporting the metallic microdroplets on a solid support.

In some embodiments of the third aspect, the method further comprises cooling the high-temperature solvent comprising the metallic microdroplets to below the melting point of the metallic alloy and/or any intermetallic compound that can be formed therein.

In some embodiments, the metallic alloy forms an immiscible mixture, preferably an emulsion, with the high-temperature solvent.

In some embodiments, the droplet formation temperature is also selected to be lower than the maximum temperature that the high-temperature solvent is stable, and higher than the melting point of the high-temperature solvent.

In some embodiments, the droplet formation temperature is greater than 300° C., preferably greater than 350° C., and more preferably at least 400° C.

In some embodiments, the high-temperature solvent comprises at least one of: hexadecane; oleic acid; at least one ionic liquid; at least one chloride salt; at least one molten nitrate and/or nitrite salt; at least one molten carbonate salt; at least one alkali metal acetate; at least one high temperature compatible hydrocarbon and/or fluorocarbon; at least one fat; or a mixture thereof.

In some embodiments, the high-temperature solvent comprises a molten salt system in which the metallic alloy is substantially immiscible.

In some embodiments, the high-temperature solvent comprises at least one alkali metal acetate salt, such as Na, K or Cs acetate or a mixture thereof, in particular anhydrous Na, K or Cs acetate or a mixture thereof.

In some embodiments, ultrasonic energy is applied to the metallic alloy within the high-temperature solvent for a duration of at least 5 minutes, such from 20 to 60 minutes, for example about 30 minutes.

In some embodiments, the applied ultrasonic energy has a frequency of 20 to 500 kHz, preferably 20 to 25 kHz and/or wherein the applied ultrasonic energy is applied with a power of 10 W to 1000 W, preferably 100 to 500 W.

In some embodiments, ultrasonic energy is applied to the metallic alloy within the high-temperature solvent using a probe sonicator.

In some embodiments, at least a proportion of the metallic microdroplets comprise (i) a solid metal alloy or intermetallic compound enriched in the at least one promotor metal element and (ii) a second metallic phase enriched in the at least one low-melting metal element when the metallic microdroplets are cooled to at room temperature. At least 50% of the metallic microdroplets, such as at least 80% of the metallic microdroplets, may comprise the solid metal alloy or intermetallic compound and the second metallic phase.

In some embodiments, at least a proportion of the metallic microdroplets comprise (i) a solid metal alloy or intermetallic compound enriched in the at least one promotor metal element and (ii) a liquid metal phase enriched in the at least one low-melting metal element when the metallic microdroplets are cooled to about 50° C. At least 50% of the metallic microdroplets, such as at least 80% of the metallic microdroplets, may comprise the solid metal alloy or intermetallic compound and the liquid metal phase.

In some embodiments, each metallic microdroplet has substantially the same metallic composition.

In some embodiments, the at least one low-melting metal element comprises gallium.

In some embodiments, the at least one promotor metal element is selected from the group consisting of copper, silver, gold, nickel, palladium, platinum, cobalt, iron, ruthenium and manganese.

In some embodiments, the at least one promotor metal element is selected from copper and magnesium. For example, the at least one promotor metal element may comprise copper.

In some embodiments, the metallic microdroplets comprise the at least one promotor metal element in an amount of between 0.1 and 20 wt. %, such as between 0.5 and 10 wt. %, for example between about 1 and 5 wt. %, based on the total weight of the metallic microdroplets.

In some embodiments, the solid support is selected from a carbon-based support, a metal support, a metal oxide support and a ceramic support.

In accordance with a fourth aspect, the invention provides a reaction system for ammonia synthesis, comprising a catalyst according to any embodiment of the second aspect, or a catalyst produced by a method according to any embodiment of the third aspect, contained within a reaction chamber configured to receive gas comprising dinitrogen and dihydrogen for reaction on the catalyst to produce ammonia.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

As used herein, the terms “first”, “second”, “third” etc in relation to various features of the disclosed devices, methods, systems etc are arbitrarily assigned and are merely intended to differentiate between two or more such features that the device, methods, systems etc may incorporate in various embodiments. The terms do not of themselves indicate any particular orientation or sequence. Moreover, it is to be understood that the presence of a “first” feature does not imply that a “second” feature is present, the presence of a “second” feature does not imply that a “first” feature is present, etc.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 illustrates a schematic of a high temperature sonication as used in some embodiments of the present invention, showing progression of droplet formation from (a) sonication start (t₀); (b) droplet formation (t₁); and (c) microdroplet formation and separation (t₂) which also illustrates a zoomed snapshot of what the microdroplets would look like.

FIG. 2 is a SEM image of metallic microdroplets comprising 2 wt. % copper in gallium, supported on carbon paper, as prepared by a high temperature dispersion methodology in Example 1.

FIG. 3 is a dark-field TEM image with EDX elemental map of a 2 wt. % copper in gallium microdroplet as prepared in Example 1, showing the presence of a copper-rich seed (302), expected to be Ga₂Cu, enclosed within the gallium-rich liquid metal composition (304).

FIG. 4 shows the gallium elemental map of the particle seen in FIG. 3, demonstrating that gallium is distributed throughout the microdroplet.

FIG. 5 shows the copper elemental map of the particle seen in FIG. 3, demonstrating that copper is concentrated in a precipitated seed enclosed within the microdroplet.

FIG. 6 shows a size distribution of metallic microdroplets comprising 5 wt. % copper in gallium, as prepared by a high temperature dispersion methodology in Example 3, with inset pie chart indicating how many microdroplets had a copper-rich metallic seed (where light grey indicates no seeds).

FIG. 7 is a graph comparing the ammonia production rate as a function of reaction temperature when using a catalyst comprising supported microdroplets of 2 wt. % copper in gallium in Example 7.

FIG. 8 is a graph comparing the ammonia production rate as a function of reactant gas pressure when using a catalyst comprising supported microdroplets of 2 wt. % copper in gallium in Example 7.

FIG. 9 is a graph comparing the ammonia production rate as a function of N₂/H₂ in the reactant gas when using a catalyst comprising supported microdroplets of 2 wt. % copper in gallium in Example 7.

FIG. 10 is a graph comparing the ammonia production rates obtained with a catalyst comprising supported microdroplets of 2 wt. % copper in gallium and a Haber-Bosch catalyst, as determined in Example 8.

FIG. 11 is a graph comparing the ammonia production rates obtained with catalysts comprising supported microdroplets of 2 wt. % copper in gallium, prepared by a high temperature dispersion method in Example 1 and prepared by a low temperature dispersion method in Example 2, as determined in Example 9.

FIG. 12 is a graph comparing the ammonia production rate obtained with a catalyst comprising supported microdroplets of 2 wt. % copper in gallium against ammonia production rates obtained with a blank carbon paper support, copper powder, and unfunctionalized supported gallium microdroplets, as determined in Example 10.

FIG. 13 is a graph showing the ammonia production rate over 32 hours of operation when using a catalyst comprising supported microdroplets of 2 wt. % copper in gallium in Example 11.

FIG. 14 is a graph showing the cumulative turnover number of ammonia production over the first 12 hours of operation when using a catalyst comprising supported microdroplets of 2 wt. % copper in gallium in Example 11.

FIG. 15 is a graph comparing the ammonia production rate obtained with a catalyst comprising supported microdroplets of 2 wt. % magnesium in eutectic gallium-indium against the ammonia production rate obtained with unfunctionalized supported gallium microdroplets, as determined in Example 12.

FIG. 16 is a graph showing the rate of HD formation when passing a mixture of H₂ and D₂ over a catalyst comprising supported microdroplets of 2 wt. % copper in gallium, with comparison against the rate of HD formation using unfunctionalized supported gallium microdroplets, as determined in Example 13.

FIG. 17 shows FTIR spectra obtained when exposing a catalyst comprising supported microdroplets of 2 wt. % copper in gallium to N₂ at different temperatures, as determined in Example 13.

FIG. 18 shows a series of FTIR spectra obtained over time after H₂ is introduced for contact with a catalyst previously exposed to N₂, the catalyst comprising supported microdroplets of 2 wt. % copper in gallium, as determined in Example 13.

FIG. 19 shows a simulation of the ammonia synthesis mechanism on a Cu—Ga alloy surface, as obtained by molecular dynamics computations in Example 14.

FIG. 20 schematically illustrates the morphology of Cu—Ga particles produced by a galvanic replacement reaction in comparative Example 15, including a Ga core and Cu nanoparticles decorated on the surface thereof.

FIG. 21 schematically illustrates the morphology of Ag—Ga particles produced by a galvanic replacement reaction in comparative Example 15, including i) Ga droplets with a nanorough surface functionalised with Ag, ii) Ga droplets with a nanorough surface functionalised with Ag and also decorated with Ag nanoflakes on the surface thereof, and iii) discrete Ag nanorods.

### DETAILED DESCRIPTION

### Method of Producing Ammonia

The present invention relates to a method of producing ammonia. The method comprises providing a catalyst comprising supported metallic microdroplets. The metallic microdroplets comprise at least one low-melting metal element selected from gallium and indium, and at least one promotor metal element selected from the group 1-2 and 7-11 metals. The catalyst is contacted with gas comprising dinitrogen and dihydrogen at a reaction temperature sufficiently high that the metallic microdroplets comprise, and typically consist of, a liquid metal alloy of the at least one low-melting metal element and the at least one promotor metal element. The dinitrogen and dihydrogen react on the catalyst to form ammonia.

### Catalyst

The catalyst provided for use in the methods disclosed herein comprises supported metallic microdroplets. It should be understood that “microdroplets” refers to droplets having a droplet size in the micron size range or smaller. The term microdroplets therefore encompasses droplets having a droplet size in the micron size range and/or in the nano size range (so called “nanodroplets”). Moreover, it should be understood that metallic microdroplets may exist in the liquid state, the solid state or mixtures thereof, depending on the composition and the catalyst temperature. For example, the supported metallic microdroplets are partly or entirely liquid when used to catalyse the reaction of dinitrogen and dihydrogen to form ammonia, but may be partly or entirely solid at room temperature.

In some embodiments, the metallic microdroplets are predominantly between 100 nm and 10 μm in size. The particle size of the metallic microdroplets may be assessed using scanning electron microscopy, with image analysis software typically used to determine the particle size distribution. The metallic microdroplets may be spheroidal in shape, consistent with the method by which they are formed in the liquid phase according to some embodiments of the invention.

The metallic microdroplets comprise at least one low-melting metal element selected from gallium and indium and at least one promotor metal element selected from the group 1-2 and 7-11 metals. Gallium and indium are known as low-melting melting elements in liquid metal compositions, both as pure liquid metals (gallium Tₘₑₗₜ=29.8° C.; indium Tₘₑₗₜ=156.8° C.) and in liquid metal alloys together with other low-melting melting elements such as tin (Tₘₑₗₜ=231.9° C.), bismuth (Tₘₑₗₜ=271.4° C.) or even zinc (Tₘₑₗₜ=419.5° C.). As with solid metals, liquid metallic compositions are characterised by metallic bonding. Metal atoms in the molten state provide electrons to an electron cloud which is shared through the bulk of the metallic composition, surrounding the positively charged metal ions and forming the metallic bonds. The delocalized electrons can freely interact with electric fields, thermal energy and light, thus providing liquid metallic compositions with high electric and thermal conductivity despite the absence of a lattice structure.

However, without wishing to be limited by any theory, the gallium and/or indium component of the catalyst is believed to play multiple roles in the methods disclosed herein. Firstly, the metallic composition of the microdroplets contains a sufficient amount of the gallium and/or indium (together with any other low-melting metal elements) that the metallic microdroplets exist partly or entirely in a liquid phase at the operating temperature of the ammonia synthesis reaction. Secondly, the low-melting metal element(s) solubilise all or part of the promotor metal element(s) in this liquid phase, so that the metallic microdroplets comprise a catalytically active liquid metal alloy of the low-melting metal element(s) and the promotor metal element(s) in the ammonia synthesis reaction. Thirdly, in at least some embodiments the gallium and/or indium is believed to play a role in the catalytic mechanism, cooperating synergistically with the promotor metal element(s) to facilitate the activation and reduction of N₂ to form ammonia. Gallium and indium are both known to form stable nitrides. By analogy, and with additional support from computational studies, it is believed that the initial steps of the ammonia synthesis mechanism may involve activation and reduction of N₂ by gallium or indium atoms at the surface of the liquid metal alloy.

The at least one promotor metal element present in the metallic microdroplets is selected from the group 1-2 and 7-11 metals (i.e. metal elements selected from group 1, group 2, group 7, group 8, group 9, group 10 and group 11 of the periodic table). While metals from both classes of elements (groups 1-2 vs groups 7-11) have been found effective by experiment, it is believed that they may operate by different mechanisms in the ammonia synthesis reaction. Group 1 and 2 metals are typically capable of reacting with N₂ to form the corresponding nitrides, and it is proposed that these elements may be directly involved in the nitrogen activation steps of the ammonia synthesis reaction, for example via in situ formation of metal nitrides. The group 7-11 metals include metals commonly used in Haber-Bosch catalysts and other catalysts for hydrogen activation reactions and may thus cooperate with the gallium and/or indium to activate the dinitrogen and/or dihydrogen. However, it is noted that the electronic structure of metal elements dissolved in liquid metal alloys may be quite distinct from that of the pure metal element in solid form, and that this may contribute to catalytic activity in the ammonia synthesis reaction. For example, copper has surprisingly been found to promote the ammonia synthesis reaction when present as an alloying element in liquid metallic microdroplets according to the present disclosure, despite the inactivity of solid copper catalysts in the Haber-Bosch process.

In some embodiments, the at least one promotor metal element comprises one or more group 7-11 metal elements selected from the group consisting of copper, silver, gold, nickel, palladium, platinum, cobalt, iron, ruthenium and manganese. In some embodiments, the at least one promotor metal element comprises one or more group 7-11 metal elements selected from the group consisting of copper, nickel, cobalt, iron and manganese, these elements all being period 4 elements. In some embodiments, the at least one promotor metal element comprises one or more group 7-11 metal elements selected from the group consisting of copper, iron and ruthenium. Iron and ruthenium are active metals for the Haber Bosch synthesis of ammonia. In some embodiments, the at least one promotor metal element comprises one or more group 1-2 metal elements selected from lithium, sodium, magnesium and calcium. In some embodiments, the at least one promotor metal element is selected from copper and magnesium. In some embodiments, the at least one promotor metal element comprises, or consists of, copper.

The metallic composition of the microdroplets preferably comprises the at least one promotor metal element in an amount where it is (i) fully soluble in the liquid metallic alloy at the operating temperature of the ammonia synthesis, and (ii) capable of promoting the ammonia synthesis reaction. It will be appreciated that the solubility limit under ammonia synthesis conditions will depend on both the solute (the promotor metal component) and the solvent (the low-melting metal element component), such information typically being available, at least for bimetallic systems, from phase diagrams for the relevant alloy system.

Therefore, in at least some embodiments, the at least one promotor metal element is fully dissolved in the liquid metal alloy at the ammonia synthesis reaction temperature. In other words, the supported metallic microdroplets of the catalyst consist of a single liquid phase, being a liquid metal alloy, when contacted with the reactant gas during the ammonia synthesis. In some embodiments, the at least one promotor metal element is fully dissolved in the liquid metal alloy at a catalyst temperature of about 400° C. or higher, preferably at a catalyst temperature of about 350° C. or higher, whether during the ammonia synthesis or otherwise.

In some embodiments, the at least one promotor metal element is present in an amount of at least 0.1 wt. %, such as at least 0.5 wt. %, for example at least 1 wt. %, based on the total weight of the metallic microdroplets. In some embodiments, the at least one promotor metal element is present in an amount of between 0.1 and 20 wt. %, such as between 0.5 and 10 wt. %, for example between about 1 and 5 wt. %, based on the total weight of the metallic microdroplets.

The promotor metal content of the metallic nanodroplets required to significantly enhance the ammonia synthesis reaction, for example compared to a comparable gallium- or indium-based liquid metal composition lacking a promoter metal element, may be above its solubility limit in the metallic composition at temperatures substantially below the ammonia synthesis operating temperature, for example at or near room temperature (e.g. less than 50° C.). In such embodiments, phase separation will occur as the initially homogeneous liquid metal alloy is cooled from high temperatures (e.g. where the alloy was prepared or the microdroplets dispersed) to below the precipitation temperature of a promotor metal-rich phase associated with the metallic composition. The catalyst will then contain at least two metallic phases at room temperature, and commonly at much higher temperatures, for example at 50° C., or 100° C., or 200° C., or even higher. The two metallic phases will generally include: (i) a solid metal alloy or intermetallic compound enriched in the at least one promotor metal element and (ii) a second metallic phase enriched in the at least one low-melting metal element (i.e. gallium and/or indium).

It should be understood that room temperature refers to the temperature being at a comfortable ambient temperature, generally taken to be between 15 to 25° C., and more particularly around 20° C.

Because the solid metal alloy or intermetallic compound enriched in the at least one promotor metal element is formed by precipitation from the molten phase upon cooling, it is present in the metallic microdroplets as one or more solid particles encapsulated within the second metallic phase enriched in the at least one low-melting metal element. The one or more solid particles may thus be confined within the interior of the metallic microdroplets, with the surface of the metallic microdroplets provided by the second metallic phase enriched in the at least one low-melting metal element. The solid metal alloy or intermetallic compound may thus be substantially absent from the surface of the metallic microdroplets. This morphology is distinguished from droplet morphologies formed by galvanic exchange, where the introduced metal is present in one or more solid phases (metallic nanoparticles or intermetallic compounds) decorated on the surface of the liquid metal droplet.

The second metallic phase may be either a solid phase or a liquid phase when the catalyst is at or close to room temperature. For gallium-based catalysts in particular, the second metallic phase may be a liquid phase at or close to room temperature, so that the metallic microdroplets will contain a solid, promotor metal-rich phase and a liquid gallium-rich phase at e.g. 50° C.

Where a binary alloy system is used, the metallic alloy composition typically comprises a primary metallic solvent (i.e. one of gallium or indium) and a lower concentration secondary metallic solute (i.e. one promotor metal element). Here, the concentration of the metallic solute is preferably selected to be higher than that of the melting/stability point to achieve intermetallic formation if the system contains both an intermetallic and a melting/stability point, or has a super saturated solute concentration if there is no intermetallic present.

To ensure that the catalyst provides good activity in ammonia synthesis, it is desirable that the promotor metal is present in sufficient, and preferably substantially equal, concentrations in most or all of the supported metallic microdroplets of the catalyst. However, the separation of two metallic phases from the target catalytic composition at low temperatures presented a significant challenge when the inventors initially attempted to prepare such a catalyst. This issue was successfully addressed by the development of a new catalyst preparation method to be described in greater detail hereafter, whereby the catalytic liquid metal alloy is dispersed by sonication at high temperatures—above the melting point of the alloy and any intermetallic compounds that can form therein—in a thermally stable high-temperature solvent.

Thus, in some embodiments, at least a proportion of the metallic microdroplets present in the catalyst comprise (i) a solid metal alloy or intermetallic compound enriched in the at least one promotor metal element and (ii) a second metallic phase enriched in the at least one low-melting metal element when the catalyst is at room temperature. For example, at least 50% of the metallic microdroplets, or at least 70% of the metallic microdroplets, or at least 80% of the metallic microdroplets, for example at least 90% or substantially all of the metallic microdroplets, may comprise the solid metal alloy or intermetallic compound and the second metallic phase. As used herein, 50% (or 80%, or 90%, or substantially all) of the metallic microdroplets refers to the number of the metallic microdroplets, as a percentage of the total population of metallic microdroplets, having this physical structure.

The proportion of the metallic microdroplets which comprise the two discrete phases can be determined by microscopic analysis, typically by transmission electron microscopy (TEM), optionally TEM coupled with Energy-dispersive X-ray spectroscopy (TEM-EDX). Typically, the microdroplets at room temperature include at least one large “seed” of the solid metal alloy or intermetallic compound, suspended or otherwise contained within the microdroplet, which is clearly visible in TEM images. The second metallic phase, enriched in the at least one low-melting metal element, may be either a liquid metal phase or a second solid phase when the catalyst is at room temperature.

In some embodiments, the metallic microdroplets comprise an intermetallic compound as the solid phase enriched in the promotor metal element. The intermetallic compound may be a crystalline/polycrystalline intermetallic compound. The composition of the particular intermetallic compound formed as a solid precipitate (or “seed”) in the microdroplets may be determined by consulting a phase diagram for the relevant alloy system, if available, or may be determined by analysis. Phase diagrams are available for a wide range of binary and ternary alloy systems. The presence of an intermetallic compound in the metallic microdroplets may be inferred from diffraction imaging of the microdroplets obtained by TEM, since intermetallic compounds will typically demonstrate a greater degree of crystalline ordering, or different diffraction characteristics, in comparison to the second metallic phase (whether liquid or solid).

For example, the stoichiometric intermetallic compound Ga₂Cu, having a melting point of 249° C., forms in the Cu—Ga alloy system, as reported in its phase diagram. Thus, at temperatures above 249° C., Cu—Ga bimetallic alloys having catalytically relevant Cu concentrations exist as a single, homogeneous liquid metal alloy phase. However, as the alloy cools below 249° C., Ga₂Cu precipitates out as a crystalline intermetallic compound. When a high proportion, or substantially all, of the microdroplets contain a similar concentration of copper, as preferred, one or more “seeds” of Ga₂Cu precipitate out in each such microdroplet. When the catalyst is heated again, for example to the operating temperature for ammonia synthesis, the Ga₂Cu phase melts and readily dissolves into the liquid metallic composition once the catalyst temperature again exceeds 249° C. Advantageously, most or all of the microdroplets thus contain a reservoir of copper to promote the ammonia synthesis reaction, despite the phase inhomogeneity of the copper-gallium alloys system at low temperatures.

The formation of well-defined intermetallic species is also expected in a wide range of other alloy systems comprising gallium and/or indium combined with catalytically significant amounts of group 1-2 and 7-11 promotor metal elements. For example, one or both of Ga₂Mg and Ga₅Mg₂ intermetallics are expected to form in the Mg—Ga alloy system.

In some embodiments, at least a proportion of the metallic microdroplets comprise (i) a solid metal alloy or intermetallic compound enriched in the at least one promotor metal element and (ii) a liquid metal phase enriched in the at least one low-melting metal element when the catalyst temperature is about 50° C., or even at about room temperature. For example, at least 50% of the metallic microdroplets, or at least 70% of the metallic microdroplets, or at least 80% of the metallic microdroplets, for example at least 90% or substantially all of the metallic microdroplets, may comprise the solid metal alloy or intermetallic compound and the liquid metal phase. Gallium-rich metallic compositions, in particular, are expected to remain liquid at ambient or near-ambient temperatures due to the very low melting temperature of gallium.

In other embodiments, at least a proportion of the metallic microdroplets comprise (i) a solid metal alloy or intermetallic compound enriched in the at least one promotor metal element and (ii) a solid alloy phase enriched in the at least one low-melting metal element when the catalyst temperature is about 50° C. Indium-based alloy systems, in particular, are expected to fall within this category. As the homogeneous liquid alloy is cooled from high temperatures, a solid phase enriched in promotor metal element, for example an intermetallic compound of indium, precipitates out of solution in the microdroplets. Upon further cooling, the indium-rich liquid phase then solidifies, so that at room temperature the metallic microdroplets include one or more promotor-rich metallic particles captured within an indium-rich solid metallic matrix.

In some embodiments, each metallic microdroplet in the catalyst has substantially the same metallic composition. As used herein, “substantially the same metallic composition” means that the wt. % of each element with each metallic microdroplet is within ±10% of the wt. % of that element in the combined composition of all the metallic microdroplets. This may be ascertained by analyzing the microdroplets by TEM-EDX, preferably at high temperature where the microdroplets exist as a single liquid phase, to determine the elemental composition.

The metallic microdroplets may comprise a single low-melting metal element selected from gallium and indium and a single promotor metal element, so that the liquid metal alloy present during the ammonia synthesis reaction is a binary metal alloy. However, it is also contemplated that the metallic microdroplets may comprise two or more low-melting metal elements, including at least one and optionally both of gallium and indium. In some embodiments, the metallic microdroplets comprise gallium and indium, or gallium, indium and tin, as the low-melting metal elements. For example, the low-melting metal element component of the metallic composition may be eutectic gallium-indium (EGaIn) or eutectic gallium-indium-tin (Galinstan) (Tₘₑₗₜ=15.0° C. and 13.2° C., respectively, in the absence of the promotor metal element). Furthermore, the metallic microdroplets may comprise two or more group 1-2 and 7-11 promotor metal elements, or even other alloying elements provided that they are compatible with the purposes and properties of the catalysts disclosed herein.

The metallic microdroplets are supported on a solid support. Suitable supports are generally those which remain solid, chemically stable, and capable of physically retaining the metallic microdroplets supported thereon under the conditions of the ammonia synthesis. Aside from these requirements, the nature of the support is not considered to be limited. For example, the support may be selected from a carbon-based support (e.g. carbon paper), a metal support, a metal oxide support (e.g. alumina, silica) and a ceramic support.

### Ammonia Synthesis Reaction

In the method of producing ammonia disclosed herein, the catalyst is contacted with a gas comprising dinitrogen and dihydrogen, at a reaction temperature sufficiently high that the metallic microdroplets comprise a liquid metal alloy of the at least one low-melting metal element and the at least one promotor metal element, thereby reacting the dinitrogen and dihydrogen to form ammonia.

Any reaction temperatures where H₂ and N₂ can react on the liquid metal alloy catalytic phase to form ammonia are suitable, and in some embodiments a reaction temperature of above 150° C., or above 200° C., for example above 250° C., may be sufficient. Preferably, the reaction temperature is sufficiently high that (i) the at least one promotor metal element is fully dissolved in the liquid metal alloy at the ammonia synthesis reaction temperature; and (ii) a satisfactory production rate of ammonia is achieved. These requirements may in some embodiments be met with a reaction temperature of above 300° C., or above 350° C., such as in the range of 350° C. to 500° C., or in the range of 350° C. to 450° C., for example about 400° C.

The catalyst may be contacted with the gas comprising dinitrogen and dihydrogen at any pressure. Higher pressures will tend to favour increased ammonia conversions when the ammonia synthesis is conducted at or near equilibrium conditions. However, in some embodiments the catalyst is contacted with the gas at pressure below those typical in the Haber Bosch process, for example a total pressure of between 1 and 100 bar, or between 1 and 50 bar, such as between 1 and 10 bar, for example between 2 and 6 bar. Thus, the increased catalyst activity obtained with the catalysts disclosed herein may advantageously be used to operate at lower reactor pressures.

The reactant gas may be fed for contact with the catalyst at any N₂:H₂ ratio, for example between 1:2 and 1:4 (v/v). Preferably, the N₂:H₂ ratio is at or close to 1:3 (v/v), consistent with the stoichiometry of the ammonia synthesis reaction shown in equation (1).

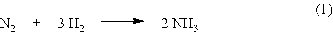

The excellent ammonia production rates obtained by the methods of this disclosure, which in some embodiments may surpass even state-of-the-art Haber Bosch heterogeneous catalysts, are attributed in part to the large catalytic surface area provided by the finely divided metallic microdroplets. Comparable interfaces between reactant gas phase and liquid metal catalytic phase cannot be provided in reactor configurations such as bubble column reactors which utilize a bulk phase liquid metal composition, due to the difficulties in controlling gas bubble size and distribution within a liquid metal column.

The microdroplet morphology has been found surprisingly stable under extended exposure to ammonia synthesis conditions, with no evidence of droplet coalescence leading to a significant loss of catalytic surface area. Moreover, the catalyst is expected to be resistant to catalyst degradation mechanisms which affect Haber-Bosch catalysts, such as hydrogen embrittlement and catalyst poisoning, since the metal atoms of the liquid composition can move freely between the bulk and surface of the liquid phase microdroplets under catalytic conditions. These advantages are evident in the substantially stable catalyst activity that was obtained over extended periods of operation.

The ammonia is believed to be produced via a catalytic process occurring on the supported metallic microdroplets, so that neither the low-melting metal element(s) nor the promotor metal element(s) are consumed stoichiometrically during ammonia synthesis. Turn over numbers (i.e. mol ammonia per mol of metal) far in excess of unity are thus achievable. There is therefore no need to regenerate the metal elements in the metallic microdroplets by stoichiometric reduction (e.g. of a metal nitride) in a separate regeneration process step, as done in a chemical looping approach. In some embodiments, therefore, the catalyst is not subjected to chemical looping. Any regeneration step which is utilized is typically performed only once the turn over number is well above unity. The ammonia synthesis reaction does not rely on a molten salt phase to facilitate any step in the reaction, such as a nitride reduction step, and thus in some embodiments the catalyst is substantially free of a molten salt phase.

The catalyst may be contacted with a gas comprising dinitrogen and dihydrogen in any suitable reactor, including batch and continuous reactors. While the supported metallic microdroplets are liquid under operating conditions, the catalyst as a whole generally presents as a solid due to the supportation of the microdroplets on a solid support. Therefore, reactor configurations conventional for gas phase reactions on heterogeneous solid catalysts may be used, such as fixed bed reactors and the like.

### Reaction System for Ammonia Synthesis

The invention further relates to reaction system for ammonia synthesis. The reaction system comprises a catalyst as disclosed herein, or a catalyst produced by the methods disclosed herein in the following section. The catalyst is contained within a reaction chamber that is configured to receive gas comprising dinitrogen and dihydrogen for reaction on the catalyst to produce ammonia.

The reaction system may comprise a source of gas comprising dinitrogen and dihydrogen, coupled to the reaction chamber. The gas may have N₂:H₂ ratio, for example between 1:2 and 1:4 (v/v). Preferably, the N₂:H₂ ratio is at or close to 1:3 (v/v), consistent with the stoichiometry of the ammonia synthesis reaction.

The source of gas comprising dinitrogen and dihydrogen, when fed to the reaction chamber, may be at any pressure. In some embodiments the gas has a total pressure of between 1 and 100 bar, or between 1 and 50 bar, such as between 1 and 10 bar, for example between 2 and 6 bar.

The reaction chamber may be within any suitable reactor, including batch and continuous reactors, as disclosed herein the context of the method of producing ammonia.

The reaction system may be configured to maintain a reaction temperature within the reaction chamber of above 300° C., or above 350° C., such as in the range of 350° C. to 500° C., or in the range of 350° C. to 450° C., for example about 400° C. The reactor may therefore be equipped with conventional heating and/or cooling equipment to maintain the reaction temperature in this range.

### Method of Producing a Catalyst for Ammonia Synthesis

The invention further relates to a method of producing a catalyst, which may be suitable for ammonia synthesis. The method comprises contacting a metallic alloy comprising (i) at least one low-melting metal element selected from gallium and indium, and (ii) at least one promotor metal element selected from the group 1-2 and 7-11 metals with a high-temperature solvent. Ultrasonic energy is applied to the metallic alloy within the high-temperature solvent, the high-temperature solvent being at a droplet formation temperature that is above the melting point of the metallic alloy, and above the melting point of any intermetallic compound that can be formed therein. The resultant liquid metallic alloy is thereby separated into metallic microdroplets of the metallic alloy within the high-temperature solvent. The metallic microdroplets are then separated from the high-temperature solvent and supported on a solid support.

This aspect of the invention thus employs a metallic microdroplet synthesis technique that uses a high-temperature solvent to suspend a catalytically active metallic alloy therein, typically as an immiscible mixture, for example an emulsion, within the designed temperature range of the system. High temperature sonication (typically greater than 200° C.) is then used to form the microdroplets, typically achieving a high yield conversion of the liquid metal alloys into microdroplets with superior morphology and homogeneity with a highly uniform elemental distribution. Each metallic microdroplet preferably has substantially the same metallic composition.

It should be understood that “high-temperature solvent” refers to the solvent used in the method being stable at the selected temperature range of high temperature sonication. As discussed below, this is typically greater than 200° C., and more preferably around or above 300° C.

The yield, composition and homogeneity of the synthesised microdroplets can be influenced by a number of parameters, including the melting and decomposition temperature of the high-temperature solvent; temperature of alloying of the metallic alloy; temperature that the ultrasonic energy to the metallic alloy within the high-temperature solvent (droplet formation temperature); duration that the ultrasonic energy is applied to the metallic alloy within the high-temperature solvent; and elemental composition of the metallic alloy. Each of these parameters can be tailored to assist in achieving highly uniform elemental distribution within a homogeneous colloidal liquid metal system.

Without wishing to be limited to any one theory, the inventors have found that homogenous production and functionalisation of liquid metal microdroplets requires careful consideration of the phases and melting temperatures in the alloy system of consideration. Here, the at least one low-melting metal element is considered as a metal solvent, and the at least one promotor metal element is considered to be the metal solute. The phase diagram of this solvent-solute system may be consulted to determine the overall melting point of the alloy system, and then the relevant melting/stability point of any intermetallic alloy or compound in that alloy system. The droplet formation temperature is then selected to be above both the melting (liquid) point of the solvent-solute system and the melting/stability point of any intermetallic alloy/compound in that solvent-solute system. This temperature selection ensures that intermetallic formation is avoided during droplet formation, thereby ensuring that the bulk metal alloy is homogeneous, and the solute metal is freely dissolved in the solvent metal. All components of the metallic alloy will therefore be substantially homogeneously distributed throughout that composition and dispersed when the composition is broken down and dispersed during sonication into the desired microdroplets.

In the absence of a phase diagram for the catalytic alloy system of interest, a suitable droplet formation temperature may be determined by experiment, for example by (i) gradually heating the bulk metal alloy until it forms a single, homogeneous liquid phase, or by (ii) cooling the bulk metal alloy from a high temperature where it exists as a single, homogeneous liquid phase and observing where precipitation occurs.

It should also be appreciated that the system temperature preferably takes the temperature limits of the high-temperature solvent into account. In this sense, the melting point and decomposition temperature of the high-temperature solvent are also a consideration in the overall system. In embodiments, the droplet formation temperature is also selected to be lower than the maximum temperature that the high-temperature solvent is stable (i.e. the decomposition temperature of the high-temperature solvent), and higher than the melting point of the high-temperature solvent. As noted above, the droplet formation temperature is also selected to be above the alloying temperature of the metallic alloy and/or the intermetallic formation temperature of the intermetallic composition.

The above limitations on droplet formation temperature are therefore dictated by selection of the high-temperature solvent and the exact metal alloy composition that is used in the system. However, in many embodiments the droplet formation temperature is greater than 300° C., and preferably greater than 350° C. In embodiments, the droplet formation temperature is from 300 to 400° C. In some embodiments, the droplet formation temperature is at least 400° C.

Overall, the droplet formation temperature of the high temperature sonication system of the present invention is typically well above ambient temperatures, typically at elevated temperatures greater than 200° C., preferably greater than 300° C. and more typically closer to about 400° C. At those temperatures conventional solvent systems break down and cannot be used.

The metallic alloy can be contacted with a high-temperature solvent using any suitable methodology. In some embodiments, the metallic alloy is introduced into the high-temperature solvent. That introduction is preferably conducted using an alloy composition. However, it is envisaged that the metallic alloy could be contacted with the high temperature solvent in other forms, and/or using other methods or actions. Other alloying methods are equally possible where there is direct contact between the powder and liquid metal. For example, the low-melting metal element and the promotor metal element could be melted together in furnace to form the desired alloy. It is also envisaged that the metallic alloy could even be formed by combining and alloying the constituent metals in the high-temperature solvent.

In embodiments, the metallic alloy forms an immiscible mixture, preferably an emulsion, within the high-temperature solvent. The metallic alloy is preferably suspended within the high-temperature solvent forming an immiscible mixture. It should be appreciated that the metallic alloy is suspended within the high temperature solvent in this immiscible mixture at any temperature that both the high-temperature solvent and the metallic alloy are liquids and are able to mix together as this immiscible mixture. This temperature (the immiscible mixing temperature) is therefore above the melting point of both the high-temperature solvent and the metallic alloy. The immiscible mixing temperature is not necessarily the same as the droplet formation temperature. However, it should be appreciated that in embodiments, the immiscible mixing temperature may be at or around the droplet formation temperature.

A suitable high-temperature solvent is selected to suit the temperature parameters of the metal solvent-solute system. The high-temperature solvent is typically a thermally stable liquid solvent that provides a liquid in which the metallic alloy composition is substantially immiscible. It should be appreciated that a large variety of high-temperature solvents can be used that have a melting point below the operating temperature range of the system (including the droplet formation temperature), and a boiling point above that operating temperature range. A large variety of high boiling point solvents can therefore be used for the high-temperature solvent. The solvent is preferably stable enough to not decompose (for example turn into carbonaceous products). The high temperature solvent is also preferably not flammable and preferably has an auto-ignition point above the operation temperature. Nevertheless, it should be appreciated that even flammable solvents can be used under a protective atmosphere.

In some exemplified embodiments, the high-temperature solvent is a molten solvent, preferably a type of molten salt, and more preferably one or more molten (alkali) acetate. However, it should be appreciated that other types of solvents can also be used as a high-temperature solvent in the method of the present invention including ionic liquids, chloride salts, molten nitrate and/or nitrite salts, molten carbonate salts and high temperature compatible hydrocarbons and/or fluorocarbons including (but not limited to) nonpolar aromatics or long chain (C12 or greater) hydrocarbons, or as oils and fats. Thus, in embodiments the high-temperature solvent can comprise at least one of: hexadecane; oleic acid; at least one ionic liquid; at least one alkali metal acetate; at least one chloride salt; at least one molten nitrate and/or nitrite salt; at least one molten carbonate salt; at least one alkali metal acetate; at least one high temperature compatible hydrocarbons and/or fluorocarbon; at least one fat (e.g. a fatty acid); or a mixture thereof. These high-temperature solvent compositions preferably have a melting temperature of from 20 to 500° C., preferably from 20 to 400° C.

In embodiments, the high-temperature solvent comprises at least one chloride salt, preferably at least one molten chloride salt. Examples include at least one of NaCl, KCl or ZnCl₂. For example, a ternary mixture of NaCl, KCl and ZnCl₂ has a melting point of between 204 to 229° C. This mixture is stable up to 1000° C., non-flammable, non-toxic with low degree of corrosiveness.

In embodiments, the high-temperature solvent comprises at least one molten nitrate or nitrite salt, preferably at least one of NaNO₃, KNO₃, or NaNO₂. For example, thermal solar salt mixture comprising 7 wt % NaNO₃, 53 wt % KNO₃, and 40 wt % NaNO₂ which is non-flammable, stable up to 535° C. They are dissolvable in water. A further example of suitable thermal solar salts comprises a mixture of sodium nitrate and potassium nitrate. For example, a eutectic mix of 60 wt % NaNO₂ and 40 wt % KNO₃ has a melting point of 220° C. and is stable up to 600° C., and can be dissolved using water and/or ethanol. This mix being non-flammable and has very low degree of corrosiveness.

In embodiments, the high-temperature solvent comprises at least one molten carbonate salt, preferably at least one of Li₂CO₃, Na₂CO₃, or K₂CO₃. For example, eutectic Li₂CO₃—Na₂CO₃—K₂CO₃ melts at 396° C.

In embodiments, the high-temperature solvent comprises at least one high temperature compatible hydrocarbons and/or fluorocarbons such as high temperature fluorocarbon polymers, nonpolar aromatics or long chain hydrocarbons (C12 or greater), preferably with normal boiling points greater than the droplet formation temperature of the designed metallic alloy system, optionally fluorinated alkanes and fatty aliphatic compounds. In some embodiments, fatty acids including stearic acid, palmitic acid, etc could also be used as the high-temperature solvent. In some embodiments, halogenated hydrocarbon solvents (also known as halogenated solvents) could also be used as the high-temperature solvent. It should be appreciated that a number of oils and fats, and many hydrocarbons or fluorocarbons are suitably stable at and/or above the droplet formation temperature of the system (i.e. does not decompose). For example, fats and/or oils, paraffin, polyethylene glycol (PEG) and PEG hydrocarbons derivatives. Examples of suitable hydrocarbons include hexadecane and longer hydrocarbons.

In some embodiments the high-temperature solvent comprises an ionic liquid. In some embodiments, the ionic liquid comprises a 1,3-dialkyl imidazolium cation, for example a 1-alkyl-3-methyl imidazolium cation where the alkyl is suitably ethyl, propyl or butyl. In some embodiments, the ionic liquid comprises a 1,3-dialkyl triazolium cation. In some embodiments, the ionic liquid comprises a fluorinated anion, for example tetrafluoroborate (BF₄⁻) or bis(trifluoromethylsulfonyl)imide (TFSI⁻). Non-limiting examples of suitable ionic liquids may include 1-ethyl-3-methylimidazolium-tetrafluoroborate, 1-butyl-3-methylimidazolium-tetrafluoroborate, 1-ethyl-3-methylimidazolium-tetrafluoroborate and 1-ethyl-3-methylimidazolium-bis(trifluoromethylsulfonyl)imide. However, it should be appreciated that other high temperature stable ionic liquids (stable at temperatures of 200° C., and more preferably around or above 300° C.) could also be used as the high-temperature solvent.

In exemplary embodiments, the inventors have found that a molten salt system can be advantageously used as a high-temperature solvent in which the metallic alloy composition is substantially immiscible therein. Molten salt systems have suitable melting points and decomposition temperatures, within the 300 to 400° C. desirable temperature range, are stable in that temperature range, are sufficiently inert, and are cost effective (for example can be obtained at low cost).

In preferred embodiments, the high-temperature solvent comprises a molten solvent, preferably an anhydrous molten solvent, more preferably at least one molten acetate salt, and more preferably an alkali metal acetate. These types of high-temperature solvents have been found to be stable at the designed droplet formation temperature, are non-corrosive, and do not contaminate the final dispersion of microdroplets or alter the end product. These salts were found to have desirable properties in the designed droplet formation temperature after an extensive search through other possible solvent systems. Alkali metal acetate salts are stable at temperatures between 100 to 400° C., allowing formulating micron and submicron-sized droplets from a wide range of metallic alloys comprising at least one low-melting metal element selected from gallium and indium, and at least one promotor metal element selected from the group 1-2 and 7-11 metals. Various alkali metal acetate salts can be used. In embodiments, the high-temperature solvent comprises at least one alkali metal acetate salt, preferably Na, K or Cs acetate or a mixture thereof, more preferably anhydrous Na, K or Cs acetate or a mixture thereof.

One or more high-temperature solvents can be used in the method of the present invention. In some embodiments, the high-temperature solvent comprises a single solvent composition, for example a single alkali metal acetate. In other embodiments, the high-temperature solvent comprises a mixture of at least two different high-temperature solvents. In this respect, different high-temperature solvents, as discussed above, can be mixed to form at least a binary solvent mixture. An example of a mixture of high-temperature solvents includes mixtures of molten acetates, for example Na acetate with K acetate. It should be appreciated that the eutectic of this molten salt composition can be utilised in the method in some applications. For example, Na acetate melts at 320° C., K acetate melts at 292° C., and Cs acetate melts at 194° C. Thus, a high-temperature solvent having a selected melting temperature can be achieved by mixing then molten salts together. One example is a mixture of Na, K and Cs acetate at 14.5, 17.4, 68.1 wt. % (in total 100 wt. %) which will melt at 90° C.

The metallic alloy composition may comprise at least a binary alloy, i.e. it includes at least two different alloying metals including one low-melting metal element selected from gallium and indium and one promotor metal element selected from the group 1-2 and 7-11 metals. In some embodiments, the metallic alloy composition includes three or more different alloying metals.

Considering that the bulk metallic alloy may be transformed by the methods disclosed herein in near-quantitative yields into metallic droplets suitable for use in ammonia synthesis catalysts, the composition of the bulk metallic alloy which is contacted with the high temperature solvent may be substantially as disclosed herein in the context of the catalyst microdroplets used in the method of producing ammonia.

The application of ultrasonic energy is utilised in the present invention to break up and disperse the metallic alloy into smaller droplets, preferably microdroplets within the high-temperature solvent. In some embodiments, the resultant metallic microdroplets are predominantly between 100 nm and 10 μm in size.

The metallic alloy is dispersed by sonication at high temperatures—above the melting point of the alloy and any intermetallic compounds that can form therein—in the high-temperature solvent. The resultant microdroplets therefore each contain a similar, or substantially the same, liquid metal alloy composition. Upon cooling, to allow microdroplet recovery from the solvent and supportation on a suitable solid support, the promotor metal element may precipitate from the liquid metal alloy, for example as an intermetallic compound. However, this precipitation occurs within each microdroplet such that a substantial proportion of the microdroplets contain a “reservoir” of the precipitated promotor metal element, fully contained within the microdroplet, which melts back into the liquid metallic alloy when the catalyst is heated to the operating temperature for ammonia synthesis. As a result, the catalyst is highly active due to the microdroplet morphology and substantially homogeneous distribution of promotor metal.

It should be appreciated that the frequency, power and duration of the applied ultrasonic energy can influence the break-up and dispersion process of the metallic alloy within the high temperature solvent.

Ultrasonic energy is ideally applied to the metallic alloy within the high-temperature solvent for a sufficient duration to fully break up and disperse the microdroplets within the high-temperature solvent. The duration of application will depend on a number of parameters including volume, metal alloy composition, the size and physical dimensions of the reservoir, the shape of and power supplied to the sonicator probe, the desired final microdroplet particle size and other parameters. However, in embodiments, the ultrasonic energy is applied to the metallic alloy within the high-temperature solvent for a duration of at least 5 minutes, preferably from 20 to 60 minutes, and more preferably about 30 minutes to completely break down the bulk metallic alloy.

Similarly, the frequency and waveform of the applied ultrasonic energy can be selected to tailor process parameters such as droplet dispersion and droplet size. In embodiments, the applied ultrasonic energy has a fixed sine wave frequency in the range of 20 to 500 KHz. In some embodiments, the applied ultrasonic energy has a fixed sine wave frequency in the range of 100 to 200 KHz. In other embodiments, the applied ultrasonic energy has a fixed sine wave frequency in the range of 20 to 25 KHz. However, higher or lower frequencies may be applied. In other embodiments, the waveform of the applied ultrasonic energy can be selected from sine wave, triangle wave, square wave, sawtooth wave or pulse wave. Similarly, the power of the applied ultrasonic energy can be tailored to the particular system. In embodiments, the applied ultrasonic energy is applied with a power of 10 W to 1000 W, preferably 100 to 500 W. In one particular embodiment, the applied ultrasonic energy is applied with a power of 300 W, however, higher and lower power settings can be applied. It should be appreciated that the power setting is highly dependent on the volume and shape of the vessel and the size and/or shape of the ultrasonic applicator, for example the type and size of the probe tip of a sonic probe.

Various ultrasonic applicators can be used in the method of the present invention. In embodiments, the ultrasonic energy is applied to the metallic alloy within the high-temperature solvent using a probe sonicator.

In some embodiments, the high-temperature solvent is mechanically agitated during application of the ultrasonic energy. In these embodiments, the method further comprises: stirring or otherwise mechanically agitating the high-temperature solvent whilst applying ultrasonic energy to the metallic alloy. Various stirring speeds can be used. In embodiments, the stirring speed is at least 100 rpm.

The method of the present invention can also include a preliminary step of forming the metallic alloy prior to adding the metallic alloy to the high-temperature solvent for dispersion. In these embodiments, the method further comprises: forming the metallic alloy by melting and mixing together (i) the at least one low-melting metal element selected from gallium and indium, and (ii) the at least one promotor metal element selected from the group 1-2 and 7-11 metals. In particular embodiments, the at least one promotor metal element, when mixed into the composition, may be in the form of a powder or particulate material.

The method may comprise a step of cooling the high-temperature solvent comprising the metallic microdroplets to below the melting point of the metallic alloy and/or any intermetallic compound that can be formed therein. The metallic microdroplets are thus cooled to induce solidification of one or more solid phases.

In some embodiments, therefore, at least a proportion of the metallic microdroplets comprise (i) a solid metal alloy or intermetallic compound enriched in the at least one promotor metal element and (ii) a second metallic phase enriched in the at least one low-melting metal element when the metallic microdroplets are cooled to at room temperature. For example, at least 50% of the metallic microdroplets, or at least 70% of the metallic microdroplets, or at least 80% of the metallic microdroplets, for example at least 90% or substantially all of the metallic microdroplets, may comprise the solid metal alloy or intermetallic compound and the second metallic phase.

In some embodiments, at least a proportion of the metallic microdroplets comprise (i) a solid metal alloy or intermetallic compound enriched in the at least one promotor metal element and (ii) a liquid metal phase enriched in the at least one low-melting metal element when the metallic microdroplets are cooled to about 50° C. For example, at least 50% of the metallic microdroplets, or at least 70% of the metallic microdroplets, or at least 80% of the metallic microdroplets, for example at least 90% or substantially all of the metallic microdroplets, may comprise the solid metal alloy or intermetallic compound and the liquid metal phase. Gallium-rich metallic compositions, in particular, are expected to remain liquid at ambient or near-ambient temperatures due to the very low melting temperature of gallium.

The high-temperature solvent can be cooled to below the metallic alloy and/or intermetallic composition melting point using any suitable technique. Cooling may be through forced or applied cooling, or may be through passive or non-forced cooling techniques. Suitable techniques include ambient air cooling, convective cooling or forced/applied cooling, for example use of a heat exchanger or other cooling device such as refrigeration.

The method of the present invention includes a step of separating the metallic microdroplets from the high-temperature solvent. The separation may be conducted after cooling the high-temperature solvent, although separation at high temperature, for example by filtration, is not excluded. The separation step can be accomplished using various separation processes. In some embodiments, separation comprises at least one of filtration, vacuum filtration, sedimentation, vacuum assisted evaporation (distillation), vacuum distillation, gravity filtration, drying filtration (if in liquid form), centrifugation, cascade centrifugation, centrifugation with solvent exchange, or the like.

In some embodiments, the high-temperature solvent is diluted or dissolved with a suitable solvent, e.g. a low-boiling molecular solvent, during the separation. For example, a solid salt matrix which encapsulates the metallic microdroplets, formed by cooling the molten salt high-temperature solvent (e.g. Na, K or Cs acetate salt) may be dissolved in water before recovering the liberated metallic microdroplets, for example by filtration. As another example, an ionic liquid high-temperature solvent may be diluted with a miscible polar solvent, such as acetonitrile, prior to separation of the metallic microdroplets. In some embodiments, the separated metallic microdroplets are washed with a suitable solvent to remove any residual traces of the high-temperature solvent.

The method of the present invention includes a step of supporting the metallic microdroplets on a solid support. Suitably, this step is performed after separating the metallic microdroplets from the high-temperature solvent. However, it is not excluded that supportation and solvent separation may be performed simultaneously.

The metallic microdroplets may be supported on the solid support by any method. In some embodiments, the metallic microdroplets are dispersed in a liquid carrier, for example a low-boiling organic solvent such as ethanol, when contacted with the support. The method my therefore include a step of redispersing the metallic microdroplets in a liquid carrier, for example using ultrasonic energy. The dispersion of metallic microdroplets may then be drop cast or otherwise applied to the support. After removal of the liquid carrier, the metallic microdroplets remain adhered to the support. It has been observed that the metallic microdroplets adhere readily and robustly to solid supports such as carbon paper, thus ensuring that the metallic composition remains finely divided for subsequent use in catalysis.

Suitable supports are generally as disclosed herein in the context of the catalytic microdroplets used in the method of producing ammonia. For example, the support may be selected from a carbon-based support (e.g. carbon paper), a metal support, a metal oxide support (e.g. alumina, silica) and a ceramic support.

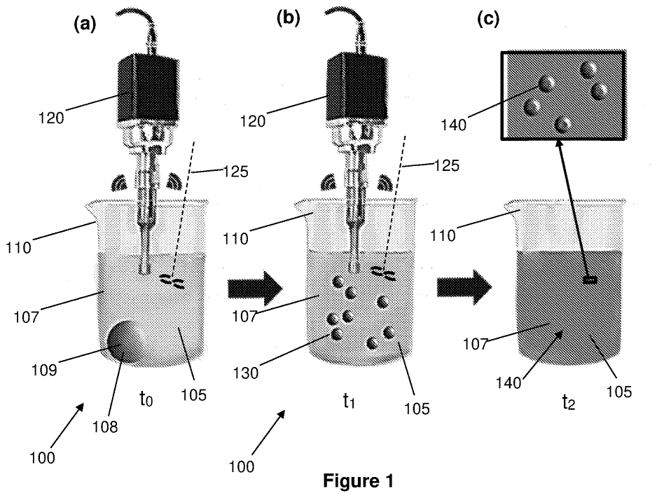

FIGS. 1(a) to 1(c) illustrates one embodiment of an apparatus/system 100 for synthesising metallic microdroplets 140 according to the present invention. As illustrated, the system 100 comprises:
(A) a reservoir 105 containing a high-temperature solvent 107 and a metallic alloy 108 comprising (i) at least one low-melting metal element selected from gallium and indium, and (ii) at least one promotor metal element selected from the group 1-2 and 7-11 metals, the high-temperature solvent being at a temperature in which the metallic alloy 108 is substantially immiscible therein. In the illustrated system 100, the reservoir 105 is contained within a beaker 110 (or glass vial). However, it should be appreciated that any suitable high temperature fluid holding container could be used.
(B) a sonicator 120 configured to apply ultrasonic energy to the metallic alloy 108 within the high-temperature solvent 107 within the reservoir 105. In the illustrated embodiments, the sonicator comprises a sonic probe. However, it should be appreciated that any suitable ultrasonic applicator could be used.
(C) a heating device (not illustrated) operational to heat the high-temperature solvent to a droplet formation temperature that is above the melting point of the metallic alloy, and above the melting point of any intermetallic compound that can be formed therein. The heating device can comprise any suitable heating arrangement including heat exchangers, ovens, furnaces, heating plates, heating mantles, induction heating, microwave heating, or the like.

The high-temperature solvent is also preferably mechanically agitated. As illustrated in broken lines in FIGS. 1(a) and 1(b), the system can further comprise:
(D) a stirrer or other mechanically agitator 125 immersed in the high-temperature solvent. Various stirring speeds can be used. In embodiments, the stirring speed is at least 50 rpm, preferably at least 100 rpm. An example of one suitable stirrer is a magnetic stirrer. However, it should be appreciated that other stirrers, impellers and/or rotors could be used.

Whilst not illustrated, the system 100 can include a cooling arrangement which is operatable to cool the high-temperature solvent to below the metallic alloy and/or intermetallic composition melting point, and preferably to room temperature. The cooling arrangement can comprise any suitable cooling apparatus for example a heat exchanger or other cooling device such as refrigeration (not illustrated).

The system 100 may also include a separation arrangement (not illustrated) for separating the microdroplets 140 from the high-temperature solvent 107. Various separation arrangements could be used, for example one of filtration, vacuum filtration, sedimentation, vacuum assisted evaporation (distillation), vacuum distillation, gravity filtration, drying filtration (if in liquid form), centrifugation, cascade centrifugation, centrifugation with solvent exchange, or the like.

In operation, the sonicator 120 is operated to applying ultrasonic energy to the metallic alloy 108 within the high-temperature solvent 107 when at the droplet formation temperature (FIGS. 1(a) and 1(b)) to separate the liquid metallic alloy 108 into colloidal microdroplets 140 within the high-temperature solvent (FIG. 1(b), thereby forming microdroplets 140 of the metallic alloy 108. With reference to FIG. 1:
At t₀ (FIG. 1(a)): an immiscible mixture is formed of a binary metallic alloy 108 within a high-temperature solvent 107.
At t₀ (FIG. 1(a)): the heater (not illustrated) is operated to ensure the high-temperature solvent 107 and metallic alloy 108 is at the selected droplet formation temperature. A thermocouple is used to measure the temperature of the constituents in the beaker 110. At the droplet formation temperature, the sonicator 110 is operated to apply ultrasonic energy to the metallic alloy 108 within the high-temperature solvent 107. The stirrer 125 is optionally operated during this period to add additional agitation to the high-temperature solvent 107.
At t₁ (FIG. 1(b)): After operation of the sonicator 110 and/or stirrer 125 for a short duration, the liquid binary metallic alloy is broken up into a plurality of droplets 130 dispersed within the high-temperature solvent 107. The sonicator continues to operate, for example to a total duration of 30 minutes. The stirrer 125 is optionally operated during this period to add additional agitation to the high-temperature solvent 107. It should be appreciated that the optimal total duration of sonication may change with the shape of the vessel, probe-shape of the sonicator 110 and power settings.
At t₂ (FIG. 1(c)): Microdroplets 140 are formed through further dispersion and droplet division as shown by the darker liquid in the beaker 110 in FIG. 1(c), and as shown in the blown-up section of the liquid in FIG. 1(c). The sonicator 120 and stirrer 125 (if operated) are turned off.
After t₂ (not illustrated): The high-temperature solvent 107 can be cooled to below the melting point of the metallic alloy and/or any intermetallic compound that can be formed therein, and in most cases can be cooled to around room temperature. The formed microdroplets 140 can then be separated from the high-temperature solvent 107 using any suitable separation process or arrangement, for example filtration.

It should be appreciated that the metallic alloys and high-temperature solvents that can be used in the system illustrated in FIG. 1 are as previously discussed.

Once microdroplets 140 are prepared by sonication, and separated from the high-temperature solvent 107, they may be supported on a suitable solid support as disclosed herein.

### EXAMPLES

The present invention is described with reference to the following examples. It is to be understood that the examples are illustrative of and not limiting to the invention described herein.

### Materials and Methods

Gallium with a purity of 99.9% were purchased from Indium Corporation, Clinton, New York, United States. Copper powder with a purity of 99.9% were purchased from Sigma Aldrich, Australia. Sodium acetate with a purity ≥99% was used from Sigma-Aldrich. 1-Ethyl-3-methylimidazolium tetrafluoroborate with a purity of ≥99% was purchased from Sigma Aldrich.

Scanning electron microscopy (SEM) images were obtained with a Tescan MIRA3 SEM instrument and processed with Aztec software v3.3.

Transmission electron microscopy (TEM) was performed using a JEOL F200 cold field emission gun system operating at an acceleration voltage of 200 kV and equipped with a bright-field Gatan Rio16 4k charge-coupled device (CCD) camera (model 1816). Gatan Digital Micrograph 1.8.4 software suite was used for imaging and analysis.

Energy-dispersive X-ray spectroscopy (EDS) was operated in the STEM mode using an JEOL F200 system equipped with an Oxford X-Max20 EDX Detector (2014) and Aztec software v3.3. This allowed for elemental mapping of each functionalised droplet.

### Example 1

A bimetallic bulk alloy comprising 2 wt. % copper metal balance gallium (2% Cu—Ga bulk alloy) was prepared using a mechanical grinding method. Thus 2 wt. % Cu metal was mixed with 98 wt. % Ga at 400° C. for 30 minutes to ensure the complete dissolution of Cu in Ga, using a mortar and pestle in a glovebox to avoid oxidation. Once alloying was finished, the metallic mixture was then placed on a watch glass to cool and then placed in a refrigerator to store in its solid phase (melting point close to room temperature).

The synthesis apparatus for producing liquid metallic microdroplets for the catalyst is schematically illustrated in FIG. 1. A vial containing the ionic liquid 1-ethyl-3-methylimidazolium tetrafluoroborate (10 ml) was placed on a hotplate equipped with an aluminium block to retain and heat the vial, and the ionic liquid was heated to 300° C. Once at temperature, the 2% Cu—Ga bulk alloy (1.5 g) was added to the ionic liquid, allowed to completely melt and stirred at 100 rpm. A SCIENTZ-IID probe sonicator, equipped with a 6 mm titanium tip, was inserted into the liquid to sonicate the liquid metal composition at a power of 300 W, operating 3 second on 3 seconds off through the 30 minute sonication period. It was observed that all of the bulk metal dispersed into the solvent as a result of the sonication, consistent with the formation of a colloidal system of metallic microdroplets in the solvent.

The temperature at which the mixture was sonicated (i.e. 300° C.) was selected to be: (i) at a temperature where the ionic liquid is sufficiently stable; and (ii) above the 249° C. melting temperature of the intermetallic compound Ga₂Cu which is expected to form according to the phase diagram for the Cu—Ga system. Therefore, the metallic composition was a single homogeneous liquid metal phase when subjected to sonication.

The dispersed microdroplets were then extracted from the ionic liquid carrier by cooling to room temperature, diluting with acetonitrile, filtering on glass fibre filter paper and washing the filtered microdroplets with further acetonitrile and then ethanol to remove traces of ionic liquid. The microdroplets were then re-dispersed in 90 vol % ethanol (balance water) and sonicated in an ultrasonic water bath for 2 minutes to evenly disperse the microdroplets throughout the ethanol carrier.

The microdroplets (2% Cu—Ga) were then loaded onto carbon paper, as a suitable inert substrate for catalysis studies, by drop casting the dispersion of microdroplets in ethanol. The samples were then dried on a hot plate at 100° C. to remove traces of solvent. It was observed that the supported microdroplets are robust and stick firmly to the carbon paper without coalescing.

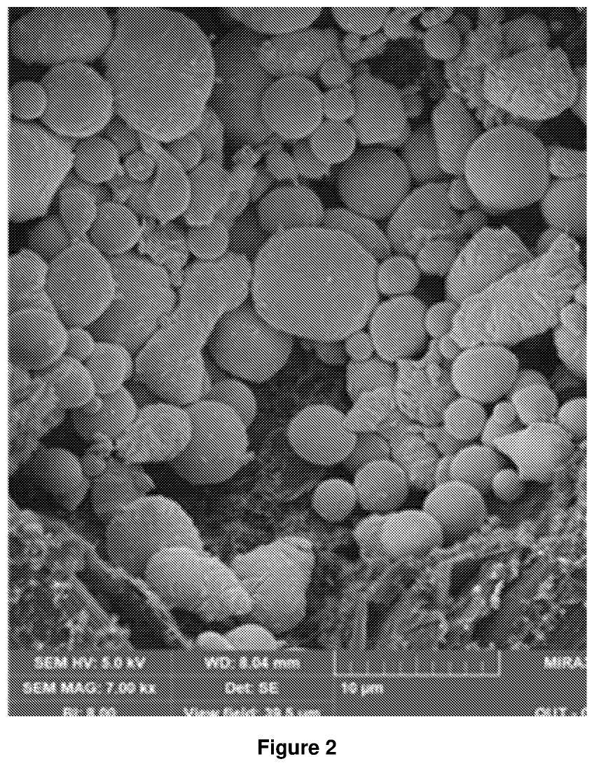

The supported microdroplets were analyzed via SEM, with a representative image shown in FIG. 2. The metallic microdroplets observed in the SEM imaging are predominantly spherical. Microdroplets with a particle size of between 1 and 10 μm stand out in the SEM images, but it is expected that smaller droplets in the range of 50 nm to 1 μm are also present.

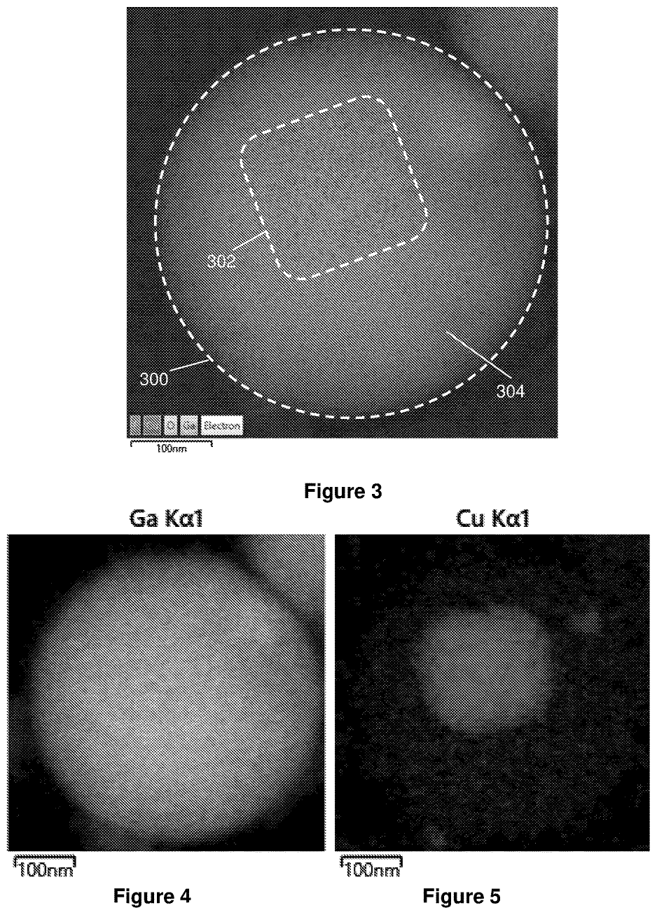

The metallic microdroplets were prepared for TEM analysis by drop-casting the dispersion of microdroplets in ethanol onto a carbon-formvar Au grid. FIG. 3 shows a dark field TEM image of a representative spherical microdroplet (300) with EDX elemental map showing the presence of a copper-rich seed (302), expected to be Ga₂Cu, enclosed within the gallium-rich liquid metal composition (304) (white dashed lines shown as guides to the seed and droplet shapes). FIGS. 4 and 5 show only the Ga and Cu elemental maps of the same microdroplet respectively. Gallium is distributed throughout the microdroplet but the copper is concentrated within the seed.

The results demonstrate that the copper concentration present in the fully liquid microdroplet when initially produced by sonication at 300° C. exceeded the low temperature solubility of copper in gallium. Accordingly, as the microdroplet cooled to below the melting point of Ga₂Cu, this intermetallic phase crystallized out as a seed. Advantageously, the seed acts as a reservoir of copper in the microdroplet, so that a high concentration of alloyed copper is present in the liquid metal microdroplet when returned to high temperature as required to catalyze the ammonia synthesis reaction.

The homogeneous distribution of the copper throughout the microdroplets was evident from the presence of copper-rich Ga₂Cu seeds in each of the microdroplets, as observed by TEM imaging of multiple microdroplets.

This result demonstrates the benefit obtained by sonicating the 2% Cu—Ga alloy at high temperature in the ionic liquid solvent, i.e. above the melting point of all phases (alloy and intermetallic) associated with the composition. Because the metallic composition is a single and homogenous liquid metal phase during sonication, the composition of each resultant microdroplet is substantially the same. Despite the intraparticle inhomogeneity at ambient conditions due to precipitation of the copper-rich seed, each 2% Cu—Ga microdroplet contains substantially the same high concentration of alloyed copper present in an entirely liquid metal composition when returned to high temperature as required to catalyze the ammonia synthesis reaction.

### Example 2

A small amount (0.5 g) of the 2% Cu—Ga bulk alloy (as prepared in Example 1) was added to 90 vol % ethanol (5 ml) and sonicated in an ultrasound bath for 30 minutes at room temperature. It was observed that the molten metallic composition did not fully disperse into the solvent under these conditions. The microdroplets that were dispersed (2% Cu—Ga-LT) were then loaded onto carbon paper by drop casting the dispersion. The samples were then dried on a hot plate at 100° C. to remove traces of solvent.

SEM and TEM analysis revealed that most of the microdroplets lacked copper seeds. TEM-EDX analysis indicated that the amount of copper in the microdroplets was much less than 2 wt. %: in the range of 0.1-0.3 wt % for most particles.

### Example 3

Metallic microdroplets containing 5 wt. % copper in gallium (5% Cu—Ga) were prepared by a similar high temperature dispersion methodology as example 1, except that anhydrous sodium acetate was used as the high-temperature solvent.

A bimetallic bulk alloy comprising 5 wt. % copper metal, balance gallium (5% Cu—Ga bulk alloy) was prepared by the same mechanical grinding method reported in Example 1. A vial containing anhydrous sodium acetate (15.3 g; melting point 324° C.; 10 ml volume after melting) was heated to 400° C. on the hotplate. Once at temperature, the 5% Cu—Ga bulk alloy (about 1-1.5 g) was added to the molten sodium acetate, allowed to completely melt and stirred at 100 rpm. The probe sonicator was inserted into the liquid to sonicate liquid metal composition at a power of 300 W, operating 3 second on 3 seconds off through the 30 minute sonication period. The temperature at which the mixture was sonicated (i.e. 400° C.) was selected to be: (i) a temperature where the sodium acetate is liquid but thermally stable; and (ii) above the 249° C. melting temperature of the intermetallic compound Ga₂Cu. All of the bulk metal dispersed into the solvent as a result of the sonication, consistent with the formation of a colloidal system of metallic microdroplets in the solvent.

After the sonication, the solution was allowed to cool to room temperature and solidify. Deionized water was then added to dissolve the sodium acetate and the mixture was vacuum filtered through 0.4 μm sized filter paper, with additional water washing to remove traces of the sodium acetate. The droplets were then redispersed in 90 vol % ethanol and sonicated in an ultrasonic water bath for 2 minutes to evenly disperse the microdroplets throughout the ethanol carrier. The dispersion was drop cast onto carbon-formvar Au grids for analysis of the microdroplets.

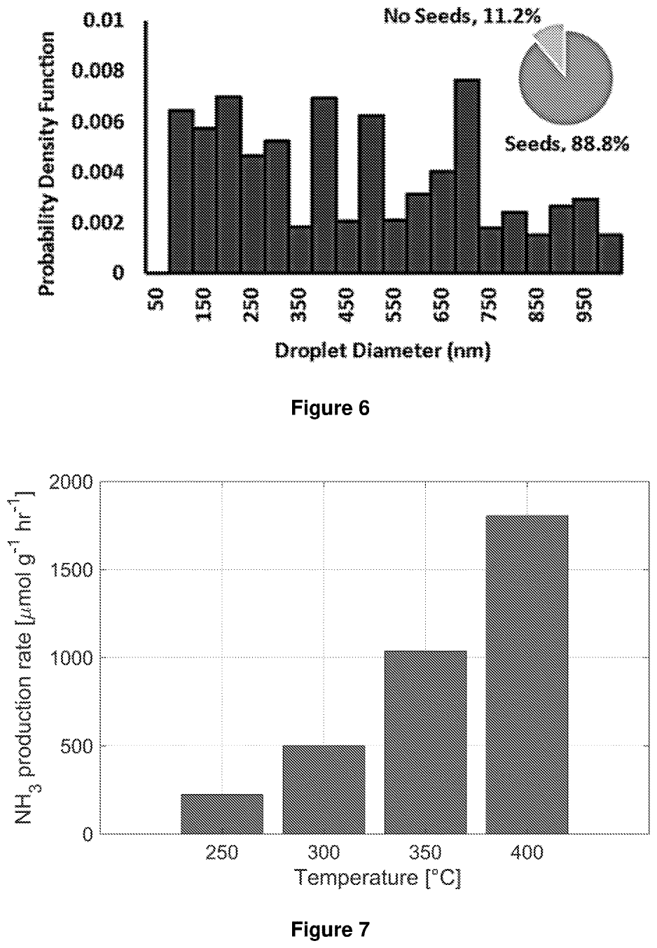

The resultant 5% Cu—Ga microdroplets were analysed by SEM and TEM. The microdroplet size distribution, obtained by particle size analysis of the SEM images (Aztec software), is show in FIG. 6. Spherical microdroplets in the range of 100 nm to greater than 1 μm were again formed. TEM analysis revealed that about 89% of the microdroplets contained observable copper-rich seeds (i.e. Ga₂Cu) contained within the gallium-rich liquid metal composition of the microdroplets.

### Example 4

Metallic microdroplets containing 5 wt. % copper in gallium (5% Cu—Ga-LT) were also prepared by a low temperature dispersion method. The bimetallic bulk alloy comprising 5 wt. % copper metal balance gallium (5% Cu—Ga bulk alloy as prepared in Example 3) was added to a vial containing 90 vol % ethanol (10 ml), heated to 55° C. and stirred at 100 rpm. The probe sonicator was inserted into the liquid to sonicate the liquid metal composition at a power of 300 W and operating 3 second on, 3 seconds off through the 30 minute sonication period. It was observed that much of the bulk metal remained undispersed in the vial, indicating a low yield synthesis of microdroplets.

Once the sonication had finished, a portion of the liquid phase was drop-cast onto a TEM grid to analyze the metallic microdroplets dispersed in the liquid. TEM analysis of the resulting metallic microdroplets revealed that only 2.8% contained copper-rich seeds. It is evident that copper was unevenly distributed through the liquid metallic microdroplets.

### Example 5

The generality of the catalyst synthesis method developed in Example 3 was shown by preparing metallic microdroplets with the following compositions: 2.8% Cu—In, 2.7% Ni—Ga, 2% Pt—Ga, 10% Ag—In, 15% Ag—Ga. In each case, a bimetallic bulk alloy was initially prepared by the same mechanical grinding method reported in Example 1. Thereafter, the bimetallic bulk alloy (1-1.5 g) was added to a vial containing molten sodium acetate (10 ml) at 400° C., and sonicated with the probe sonicator (300 W, 30 seconds on, 30 seconds off for 30 minutes). The dispersion temperature was higher than the melting point of any intermetallic compounds known for these alloy systems. All of the bulk metal dispersed into the solvent as a result of the sonication, consistent with the formation of a colloidal system of molten metallic microdroplets in the solvent.

After cooling, aqueous work-up and redispersion in 90 volume % ethanol (as per Example 3), the microdroplet dispersion was drop cast onto carbon-formvar Au grids for SEM and TEM/EDS analysis. The presence of precipitated “seeds” enriched in the promotor metal (believed to be intermetallic compounds in each case) was evident in most of the microdroplets. Results for selected microdroplet compositions produced in Examples 3 and 5 is summarised in Table 1.

TABLE 1

| Microdroplet | Mean microdroplet | % of microdroplets |
|---|---|---|
| composition | diameter (nm) | containing a “seed” |
| 5% Cu—Ga (Ex 3) | 511 ± 379 | 88.8 |
| 2.8% Cu—In (Ex 5) | 840 ± 370 | 100 |
| 15% Ag—Ga (Ex 5) | 684 ± 394 | 99.0 |

### Example 6

A bimetallic bulk alloy comprising 2 wt. % magnesium metal, balance eutectic gallium-indium (2% Mg-eGaIn bulk alloy) was prepared by the same mechanical grinding method reported in Example 1 (starting with preformed eGaIn).

Metallic microdroplets containing magnesium in eutectic gallium-indium (2% Mg-eGaIn-LT) were then prepared by a low temperature dispersion method. The 2% Mg-eGaIn bulk alloy was added to a vial containing 90 vol % ethanol (10 ml), heated to 55° C. and stirred at 100 rpm. The SCIENTZ-IID probe sonicator was inserted into the liquid to sonicate the liquid metal composition at a power of 300 W and operating 3 second on, 3 seconds off through the 30 minute sonication period. The majority of the alloy was seen to disperse into the solvent.

The dispersed microdroplets (2% Mg-eGaIn-LT) were then loaded onto carbon paper by drop casting the dispersion. The samples were then dried on a hot plate at 100° C. to remove traces of solvent.

### Example 7

Catalyst activity in the ammonia synthesis reaction was evaluated according to the following general procedure. The supported catalyst for evaluation (~1.5 mg in total weight including the carbon paper support and supported metallic microdroplets; the microdroplets were loaded on the support in about 10 wt. %) was loaded on top of an inert HVC screen (150 mesh) in a reaction chamber (18 ml capacity). The catalyst was initially pre-treated under an inert He feed at 250° C. for 2 hrs and then under a gaseous mixture of N₂/H₂ at 450° C. and 4 bar for 4 hrs. The chamber was then purged with He at room temperature for 3 hrs to remove all reactive gases or products remaining in the chamber. The ammonia synthesis evaluation then commenced with a gas feed of nitrogen and hydrogen (N₂:H₂ ratio of 1:3 v/v unless otherwise specified), operating under differential conditions (i.e. negligible ammonia partial pressure), at the desired operating temperatures and pressures for several 10 minute cycles. After each cycle, the produced ammonia was collected by bubbling the gas effluent from the reactor through 5 mM H₂SO₄ and analyzed by colorimetric method (Nessler's reagent) and NMR. The reactor was then re-filled with gas reagent to begin the next cycle.

The activity of the 2% Cu—Ga catalyst (supported on carbon paper; as produced in Example 1) was evaluated at different reaction temperatures at 4 bar total gas pressure, and the results are shown in FIG. 7. At 400° C., the ammonia production rate was over 6000 μmol·g⁻¹·hr⁻¹, based on the mass of the metallic nanodroplets (Cu+Ga). Lower activity was obtained at 500° C., indicating that the peak activity is likely between 350° C. and 450° C.

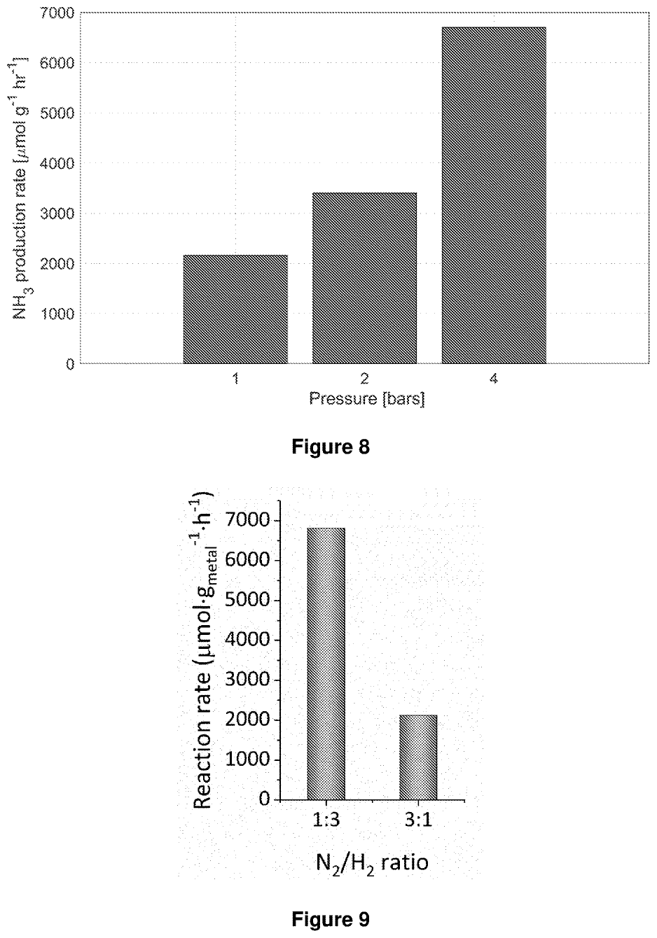

The activity of the 2% Cu—Ga catalyst was also evaluated at different reaction pressures at 400° C. reaction temperature, and the results are shown in FIG. 8. Higher pressures increase the rate of ammonia formation, consistent with the ammonia synthesis being an equilibrium. However, appreciable ammonia formation rates were obtained even at atmospheric pressure.

The effect of N₂/H₂ ratio (1:3 vs 3:1 v/v) in the gas feed was also evaluated, with the results shown in FIG. 9. The higher activity was obtained at a feed ratio of N₂/H₂ ratio 1:3 v/v, consistent with the stoichiometry of the ammonia synthesis reaction.

The 2% Cu—Ga catalyst was recovered after the reactions and analysed by SEM. The supported liquid metallic microdroplets remain intact post-reaction.

### Example 8

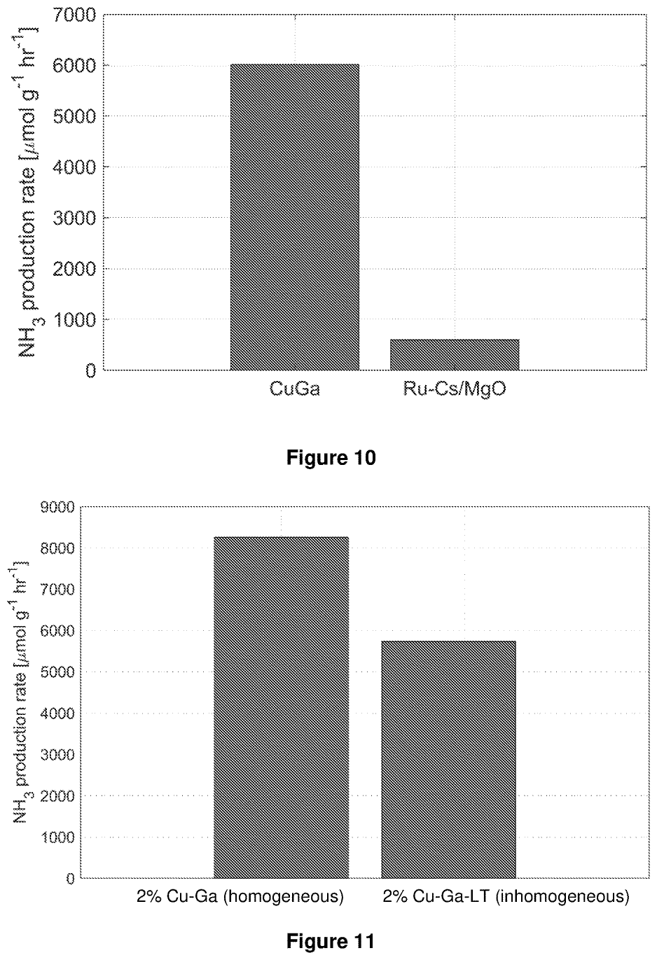

The ammonia synthesis activity of the 2% Cu—Ga catalyst, supported on carbon paper (as produced in Example 1) was compared against that of a state-of-the art Ru-based Haber-Bosch heterogeneous catalyst (Ru—Cs/MgO; activity based on mass of Ru+Cs) at 400° C. and 4 bar pressure (general procedure of Example 7), and the results are shown in FIG. 10. A very significant increase in activity is evident for the liquid metal 2% Cu—Ga catalyst compared to the heterogeneous catalyst. The increased activity obtained with the liquid metal catalyst provides the opportunity to operate an ammonia synthesis process at significantly reduced pressure compared to typical Haber-Bosch processes while obtaining a similar conversion.

### Example 9

The ammonia synthesis activity of the 2% Cu—Ga catalyst with homogeneously-distributed copper (as prepared in Example 1) was compared against that of the 2% Cu—Ga-LT catalyst with inhomogeneously distributed copper (as prepared in Example 2), at 400° C. and 4 bar pressure (general procedure of Example 7), and the results are shown in FIG. 11. The catalyst obtained by the high temperature dispersion method had about 40% higher catalyst activity.

### Example 10

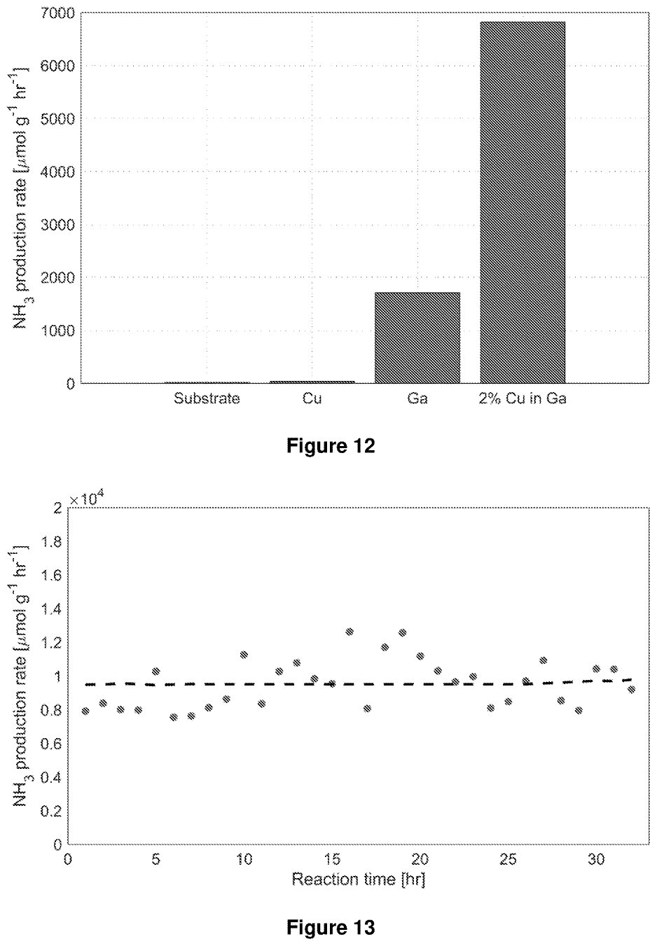

To confirm that the excellent ammonia synthesis activity of the 2% Cu—Ga catalyst, as determined in Example 7, was caused by a cooperative effect between the Cu and Ga components, ammonia synthesis reactions were also conducted with the carbon paper substrate by itself, unsupported metallic copper powder and pure gallium microdroplets supported on carbon paper substrate. The results are shown in FIG. 12 (400° C. and 4 bar pressure; general procedure of Example 7).

The substrate and copper metal had negligible activity for ammonia synthesis. Gallium microdroplets displayed some activity without promotion by any alloying metal, but it is clear that a very significant enhancement is obtained when the microdroplets contain 2 wt. % copper content present in the liquid gallium-based alloy.

### Example 11

The longer term stability of the 2% Cu—Ga catalyst, supported on carbon paper (as produced in Example 1), in the ammonia synthesis reaction was then evaluated. The extended reaction was conducted as a series of 1 hour batch reactions at 400° C., N₂/H₂ ratio 1:3 v/v and 4 bar total pressure, for 32 hours in total. In each cycle, the reaction chamber was filled with the reactant gas, allowed to react on the catalyst for one hour, depressurised for analysis, and then re-filled with the reactant gas to commence the next cycle.

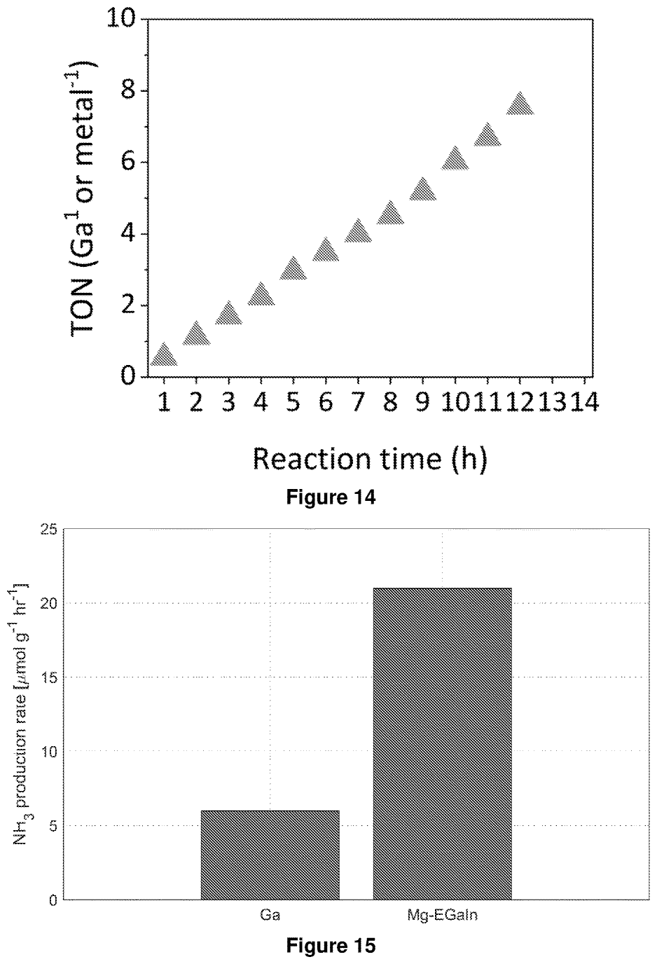

The ammonia production rate over 32 hours is shown in FIG. 13, and the cumulative turnover number over the first 12 hours is shown in FIG. 14. The reaction was found to be highly stable over 32 hours of operation with reaction rates of about 1×10⁴ μmol·g⁻¹·hr⁻¹. FIG. 14 demonstrates that the process is catalytic. Since the turn over number (TON) is well above 1, more ammonia is made than can be explained by a simple reduction process in which metal is consumed.

The demonstrated stability of the 2% Cu—Ga catalyst is highly advantageous given that one of the most prominent limitations to the use of solid state-of-the-art catalysts in ammonia production is the loss of activity observed at prolonged timescales. Without limitation by theory, it is believed that liquid metal catalysts (such as the 2% Cu—Ga catalyst) are resistant to hydrogen embrittlement and surface fouling, at least in part due to the dynamic renewal of the catalytic surface of the microdroplets by the mobile metal atoms in the liquid metal composition.

### Example 12

The ammonia synthesis activity of the 2% Mg-eGaIn catalyst (as prepared in Example 6) was then evaluated at 400° C. and 4 bar pressure (general procedure of Example 7). The results, with comparison against unpromoted gallium microdroplets, are shown in FIG. 15. The addition of magnesium was found to very significantly increase the activity, by about four-fold.

### Example 13

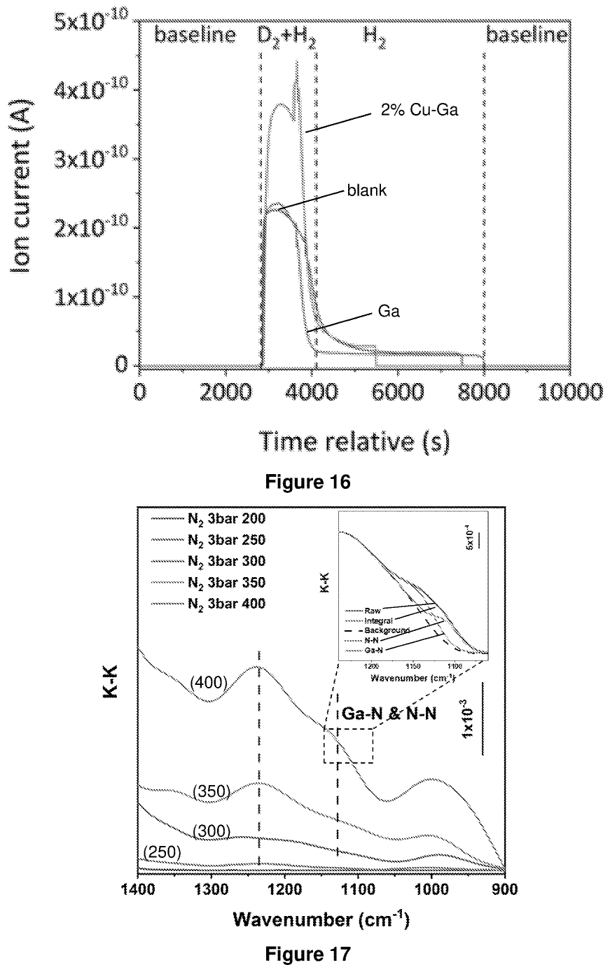

The hydrogen activation ability of the liquid metal microdroplet catalyst was investigated by passing a physical mixture of H₂ and D₂ over the catalyst at 400° C. and measuring the formation rate of HD. The same reactor system as in Example 7 was used, and a mass-spectrometry gas analyser was used to determine the product distribution. Comparative reactions were conducted with the 2% Cu—Ga catalyst, supported on carbon paper (as produced in Example 1), with pure gallium microdroplets supported on carbon paper and without any catalyst in the reactor (blank experiment). As seen in FIG. 16, hydrogen is activated when contacted with the 2% Cu—Ga catalyst whereas gallium microdroplets lacking Cu (or other promotor) were inactive (no improvement over blank). The result strongly suggests that copper plays a role in hydrogen activation during the ammonia synthesis reaction over liquid metal catalysts.

Since N₂ activation is widely considered the rate limiting step in conventional ammonia production processes, the ability of liquid metal catalysts to activate and dissociate N₂ is of significant interest. The interaction of the 2% Cu—Ga catalyst (as produced in Example 1) with N₂ was thus investigated by in situ FTIR experiments. The same reactor system as in Example 7 was used, with the catalyst observed through a IR-transparent window.

FIG. 17 shows the FTIR spectra when the 2% Cu—Ga catalyst is exposed to N₂ at 3 bar pressure and at various temperatures between 200° C. and 400° C. The results demonstrate the co-existence of Ga—N and N—N bonds in the sample at higher reaction temperatures, indicating the capability of the catalyst to activate N₂.

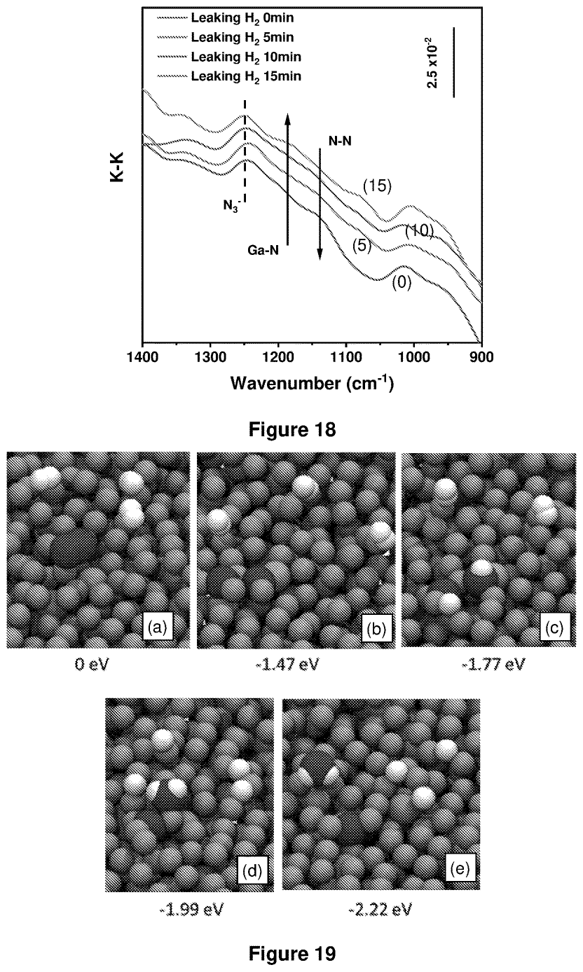

FIG. 18 shows the FTIR spectra over time when the 2% Cu—Ga catalyst is initially exposed to N₂ at 3 bar pressure and 400° C. (0 minutes), followed by leaking H₂ into the chamber (spectra taken after 5, 10 and 15 minutes of H₂ exposure). The results indicate an increase in Ga—N and a decrease in N—N bonds as H₂ is fed into the chamber.

The H₂/D₂ activation and FTIR-observed N₂ activation experiments together suggest a synergistic cooperation between Cu and Ga in the liquid metal alloy during ammonia synthesis, whereby Ga actives nitrogen and Cu activates H₂, ultimately facilitating the conversion of N₂ and H₂ to NH₃.

### Example 14

A bulk metal alloy containing 196 gallium atoms and 4 copper atoms was simulated by molecular dynamics. Initial classical molecular dynamics (MD) simulations were carried out on 200 Ga atoms in the NVT ensemble at 673.15 K in a 15.82×15.82×15.82 Å³ box using the MD code LAMMPS. Four Ga atoms were alchemically changed to Cu, and bulk and interfacial ab initio MD (AIMD) simulations were performed for 100 ps with a 2 fs timestep in triplicate using the Vienna ab initio Simulation Package (VASP) at 673.15 K with the projector-augmented wave (PAW) method, the PBE exchange correlation functional, an energy cutoff of 320 eV, and the gamma point only for the k-point grid. For interfacial systems a 15 Å vacuum spacer was added in the z dimension.

To model the catalytic reaction, one N₂ and three H₂ molecules were added to the equilibrated interfacial system of 196 Ga and 4 Cu, and AIMD simulations were performed with a 0.5 fs timestep and 450 eV energy cutoff. Geometry optimizations were carried out on AIMD snapshots for each step in the reaction with a 4×4×1 k-point grid and Bader partial charges were calculated. All other analysis was performed using VMD 1.9.3.

The simulations showed that Cu exhibited no specific preference at the interface and migrated freely between the bulk and the outermost interfacial layer. This continuous circulation of Cu atoms between the bulk and the interface could serve to continually refresh the interface and reduce catalyst poisoning.

One possible mechanism for the ammonia synthesis reaction, as identified by the simulations, is shown in FIG. 19. The reaction of N₂ with the surface was found to be strongly energetically favourable in the presence of Cu, forming two adjacent N—Cu—Ga₃ configurations (FIG. 19 b). In this configuration, the Ga atoms directly bond to N, with the two N atoms no longer bonded. In the next step, an H₂ molecule reacts with one of the N centers, resulting in one H bonded to N and one bonded to nearby Ga (FIG. 19 c). The H bonded to N displaces one Ga atom, while the other H assumes a negative charge, with the neighbouring Ga assuming a more positive charge to compensate. Once again, the presence of the Cu distorts the geometry and provides a more exposed N for further reaction. Upon reaction with another H₂ molecule, the N-Cu bond is broken and the NH₂ configuration becomes far more exposed at the interface (FIG. 19 d), where it can react with a surface H or gaseous H₂ to form NH₃, which spontaneously dissociates from the interface.

### Example 15 (Comparative)

Ga droplets were produced that were functionalized with Cu and Ag. The Ga droplets were formed using an ultrasonic method which were subsequently functionalized with Cu and using a galvanic replacement reaction. In this comparative example, the Ga—Cu and Ga—Ag metallic alloy was NOT heated within a high-temperature solvent at a droplet formation temperature that is above the melting point of the metallic alloy, and above the melting point of any intermetallic compound that can be formed therein. This resulted in a very different droplet morphology to the droplet morphology exemplified in the preceding examples.

### Materials and Methods

### Ga Droplet Synthesis:

Gallium droplets were created using a sonication method in which 100 μl of liquid gallium metal (purity 99.9%) (Indium Corporation, Clinton, New York) was combined with 15 mL of MilliQ water before being sonicated for 5 min at 300 W with on/off times of 3 s/3 s.

### Galvanic Droplet Synthesis:

The gallium droplets were added to 0.1 M solutions of copper sulfate (CuSO₄) and silver nitrate (AgNO₃) (both-Sigma, St. Louis, Missouri) at a 1:1 ratio before being centrifuged at 10 000 RCF for 5 min. The particles were then washed and centrifuged again at 10 000 RCF for 5 min with MilliQ water, 100% ethanol twice and phosphate buffered saline (PBS) (Sigma, St. Louis, Missouri) twice to remove any residual CuSO₄ or AgNO₃ in solution.

### Scanning Electron Microscopy (SEM):

Scanning electron micrographs were obtained using an FEI Verios SEM (FEI, Oregon) at 3 kV. For cellular imaging, all samples were deposited on silicon and wafers fixed with 2.5% glutaraldehyde/formaldehyde. Samples were then washed in MQ water and dehydrated in an ethanol series (30, 60, 80, 90, and 100%) for 10 min per concentration and left in 100% ethanol overnight. The samples were air-dried for at least 1 h and coated with ~5 nm iridium before imaging. Ga droplet sizes were measured using Image J software. SEM-EDS was operated at 20 kV using an Oxford X-Max20 EDX Detector attached to the FEI Verios SEM. Data processing was performed using the Aztec software (Oxford Instruments, UK).

### Transmission Electron Microscopy (TEM):

Transmission electron micrographs were obtained using a JEOL F200, with accelerating voltage of 200 kV. The Gatan Digital Micrograph 3.43.3213.0 software suite was used for imaging and analysis with the use of Gatan Rio16 4k charge-coupled device camera (model 1816). TEM-EDS was performed with an attached Oxford X-Maxn 80T X-ray detector been used on Aztec software with the attached EDS Oxford X-Maxn 80T X-ray spectrometer. Data processing was performed using the Aztec software (Oxford Instruments, UK).

### X-Ray Diffraction (XRD):

XRD was carried out using a Bruker D4 diffractometer. XRD samples were prepared on glass substrates. XRD was performed with a 2-theta range of 5°-85° and a step size of 0.02° and a duration time of 0.1 s.

### Results and Discussion

### Ga Droplet Characterization

Ga droplets were produced from bulk Ga liquid metal (LM) in MQ water by probe sonication. The probe sonication generates nanobubbles that collapse in on themselves, generating sufficient energy to break small fragments of the Ga LM off from the bulk. These fragments of liquid Ga rapidly form an oxide layer, which prevents their coalescence and enables the formation of liquid-core, solid-shell micro- and nanoparticles that are referred to as Ga droplets. Scanning electron microscopy (SEM) images show the Ga droplets are predominately spheres or sphere-like particles. Synthesis via probe sonication can increase the temperature of the solution which increases the rate of GaOOH formation. GaOOH is crystalline and causes the droplets to resemble rod-like shapes. To mitigate against the development of GaOOH formation, the probe sonication procedure was set up in a water bath with appropriate off times to allow heat dissipation. SEM and x-ray diffraction (XRD) analysis confirmed that the particles generated were predominately smooth, without significant GaOOH formation. Due to the stochastic nature of the synthesis method, the fabricated Ga droplets had a large variation in size from <100 nm to several microns in diameter. The median droplet diameter was 180 nm.

### Functionalization of Ga Droplets

Ga droplets were functionalized with Cu using a galvanic replacement reaction. A galvanic replacement reaction occurs when a more reactive metal is combined with a metal salt of a less reactive metal. This drives an exchange of electrons causing the more reactive metal to form ions in solution while the less reactive metal ions become solid metal.

Briefly, the Ga droplets were added to 0.1 M solutions of copper sulfate (CuSO₄) or silver nitrate (AgNO₃) for 10 min and then washed thoroughly by centrifugation to remove any traces of metal ions in the solution. The resultant particles are referred to as Cu—Ga and Ag—Ga hereafter. The relevant standard reduction potential equations compared to standard hydrogen electrode (SHE) are provided below:

### Copper-Gallium

$${Ga}^{3 +} + 3 {e}^{-} ⇌ {Ga}_{( l )} = - 0 \text{.53} V \qquad ( C1 )$$

$${Cu}^{2 +} + 2 {e}^{-} ⇌ {Cu}_{( s )} = + 0.34 V \qquad ( C2 )$$

$$E ° cell = 3 {Ga}_{( l )} + 3 {Cu}^{2 +} + 6 {e}^{-} ⇌ 2 {Cu}_{( s )} + 2 {Ga}^{3 +} + 6 {e}^{-} = + 0 \text{.87} V \qquad ( C3 )$$

### Silver-Gallium

$${Ga}^{3 +} + 3 {e}^{-} ⇌ {Ga}_{( l )} = - 0 \text{.53} V \qquad ( C4 )$$

$${Ag}^{+} + 2 {e}^{-} ⇌ {Ag}_{( s )} = + 0.8 V \qquad ( C5 )$$

$$E ° cell = 3 {Ga}_{( l )} + 3 {Ag}^{+} + 3 {e}^{-} ⇌ {Ag}_{( s )} + {Ga}^{3 +} + 3 {e}^{-} = + 1.33 V \qquad ( C6 )$$

The driving force of these reactions can be determined from the following equation:

$$Δ G = - n FE ° cell \qquad ( C7 )$$

Where AG is the Gibbs free energy, n is the number of moles of electrons in a balanced redox equation and F is the faraday constant (96485.33 C mol⁻¹) with E° cell being the cell potential. Therefore the ΔG for Cu—Ga and Ag—Ga is −503.65 KJ/mol and −384.98 KJ/mol respectively. In both cases, ΔG<0 indicating a spontaneous reaction.

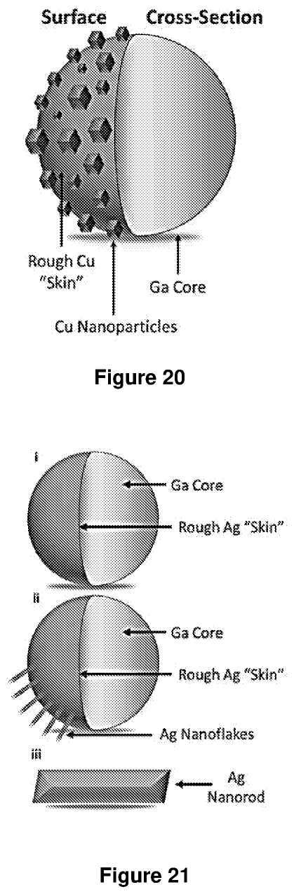

Analysis of the morphology and surface structures of the formed Cu—Ga particles by SEM displayed what seems to be small crystallite growth on the surface of the droplets, indicative of Cu nanoparticles (NPs). The surface of the particles was rough, likely due to the native oxide layer of Ga or a Cu or CuGa₂ layer. Transmission electron microscope (TEM) analysis supports the SEM images, indicating a Ga core with a surface coating consisting, at least partially, of Cu-based NPs. High-resolution TEM (HR-TEM) indicates the presence of a crystalline structure with d-spacing ~0.21 nm likely corresponding to Cu(111). However the presence of additional intermetallic species such as Ga₂Cu, GaCu₂ or Ga₄Cu₉ is also possible. XRD analysis was also performed, which indicated the crystalline species were predominately pure copper, aligning with the HR-TEM results. EDS imaging further confirms the presence of Ga and Cu on the particles. A basic schematic of the particles is provided in FIG. 20.

In contrast to the Cu—Ga particles, Ag—Ga particles took on several distinct morphologies. SEM images showed the presence of nanorough particles, nanorough particles with Ag nanoflakes and Ag nanorods on the surface of the Ga droplets. HR-TEM revealed a crystalline structure with d spacing of 0.14 nm that may correspond to AgGa (210), although pure silver may also be present. XRD analysis was also performed, which indicated the crystalline species were predominately pure silver. EDS imaging further confirms the presence of Ga and Ag on the particles. A schematic of the three broad types of particles observed is provided in FIG. 21.

The results with both Cu and Ag indicate that galvanic synthesis methodologies produce Cu- or Ag-containing phases on the surface of the Ga droplets, which retain an intact Ga metal core. The resultant droplets do not contain a solid Ga—Cu or Ga—Ag alloy or intermetallic compound particle encapsulated within the confines of the Ga droplet, as produced in the preceding examples.

Those skilled in the art will appreciate that the invention described herein is susceptible to variations and modifications other than those specifically described. It is understood that the invention includes all such variations and modifications which fall within the spirit and scope of the present invention.

1. A method of producing ammonia, the method comprising:
providing a catalyst comprising supported metallic microdroplets, the metallic microdroplets comprising (i) at least one low-melting metal element selected from gallium and indium, and (ii) at least one promotor metal element selected from the group 1-2 and 7-11 metals; and
contacting the catalyst with gas comprising dinitrogen and dihydrogen, at a reaction temperature sufficiently high that the metallic microdroplets comprise a liquid metal alloy of the at least one low-melting metal element and the at least one promotor metal element, thereby reacting the dinitrogen and dihydrogen to form ammonia.

2. The method according to claim 1, wherein the at least one promotor metal element is fully dissolved in the liquid metal alloy at the reaction temperature.

3. The method according to claim 1 or claim 2, wherein the reaction temperature is above 300° C.

4. The method according to claim 1, wherein at least 50% of the metallic microdroplets comprise (i) a solid metal alloy or intermetallic compound enriched in the at least one promotor metal element and (ii) a second metallic phase enriched in the at least one low-melting metal element when the catalyst is at room temperature.

5. The method according to claim 1, wherein each metallic microdroplet has substantially the same metallic composition.

6. The method according to claim 1, wherein the at least one low-melting metal element comprises gallium.

7. The method according to claim 1, wherein the at least one promotor metal element is selected from the group consisting of copper, silver, gold, nickel, palladium, platinum, cobalt, iron, ruthenium and manganese.

8. The method according to claim 1, wherein the at least one promotor metal element is selected from copper, iron and ruthenium.

9. The method according to claim 1, wherein the metallic microdroplets comprise the at least one promotor metal element in an amount of between 0.5 and 10 wt. % based on the total weight of the metallic microdroplets.

10. The method according to claim 1, wherein the metallic microdroplets are predominantly between 100 nm and 10 μm in size.

11. A catalyst comprising supported metallic microdroplets, the metallic microdroplets comprising (i) at least one low-melting metal element selected from gallium and indium, and (ii) at least one promotor metal element selected from the group 1-2 and 7-11 metals, wherein at least a proportion of the metallic microdroplets comprise (i) a solid metal alloy or intermetallic compound enriched in the at least one promotor metal element and (ii) a second metallic phase enriched in the at least one low-melting metal element.

12. The catalyst according to claim 11, wherein the solid metal alloy or intermetallic compound enriched in the at least one promotor metal element is present in one or more solid particles confined within the interior of the metallic microdroplets, the surface of the metallic microdroplets being provided by the second metallic phase enriched in the at least one low-melting metal element.

13. The catalyst according to claim 11, wherein at least 50% of the metallic microdroplets comprise the solid metal alloy or intermetallic compound and the second metallic phase.

14. The catalyst according to claim 11, wherein the metallic microdroplets comprise a liquid metal alloy of the at least one low-melting metal element and the at least one promotor metal element when the catalyst is heated to a temperature of about 400° C. or higher, wherein the at least one promotor metal element is fully dissolved in the liquid metal alloy.

15. (canceled)

16. The catalyst according to claim 11, wherein the at least one promotor metal element is selected from the group consisting of copper, silver, gold, nickel, palladium, platinum, cobalt, iron, ruthenium and manganese.

17. The catalyst according to claim 11, wherein the at least one promotor metal element is selected from copper, iron and ruthenium.

18. (canceled)

19. A method of producing a catalyst, the method comprising:
contacting a metallic alloy with a high-temperature solvent, the metallic alloy comprising (i) at least one low-melting metal element selected from gallium and indium, and (ii) at least one promotor metal element selected from the group 1-2 and 7-11 metals;
applying ultrasonic energy to the metallic alloy within the high-temperature solvent, the high-temperature solvent being at a droplet formation temperature that is above the melting point of the metallic alloy, and above the melting point of any intermetallic compound that can be formed therein, thereby separating the liquid metallic alloy into metallic microdroplets of the metallic alloy within the high-temperature solvent;
separating the metallic microdroplets from the high-temperature solvent; and
supporting the metallic microdroplets on a solid support.

20. The method according to claim 19, further comprising cooling the high-temperature solvent comprising the metallic microdroplets to below the melting point of the metallic alloy and/or any intermetallic compound that can be formed therein.

21. (canceled)

22. (canceled)

23. (canceled)

24. The method according to claim 19, wherein the high-temperature solvent comprises a molten salt system in which the metallic alloy is substantially immiscible.

25. (canceled)

26. (canceled)

27. (canceled)

28. (canceled)

29. (canceled)

30. (canceled)

31. A reaction system for ammonia synthesis, comprising a catalyst according to claim 11, contained within a reaction chamber configured to receive gas comprising dinitrogen and dihydrogen for reaction on the catalyst to produce ammonia.
